(19) United States
(12) Patent Application Publication
(10) Pub. No.: US 2020/0293946 A1
(43) Pub. Date: Sep. 17, 2020

(54) MACHINE LEARNING BASED INCIDENT CLASSIFICATION AND RESOLUTION

(71) Applicant: ACCENTURE GLOBAL SOLUTIONS LIMITED, Dublin 4 (IE)

(72) Inventors: Ashish SACHAN, Redmond, WA (US); Srinivasan SARAVANAMUTHU, Issaquah, WA (US); Anuj ANAND, Hyderabad (IN); Ashish KUMAR NAYAK, Hyderabad (IN); Andoju MADHAVI, Hyderabad (IN); Haraveera REDDY KALAKATA, Bellevue, WA (US); Atul CHANDRAKANT LANGOTE, Hyderabad (IN); Alok TYAGI, Sammamish, WA (US)

(73) Assignee: ACCENTURE GLOBAL SOLUTIONS LIMITED, Dublin 4 (IE)

(21) Appl. No.: 16/355,344

(22) Filed: Mar. 15, 2019

(51) Int. Cl. G06N 20/00; G06N 5/04; G06Q 10/06

(52) U.S. Cl. CPC G06N 20/00; G06Q 10/063112; G06N 5/04

(57) ABSTRACT

In some examples, machine learning based incident classification and resolution may include analyzing an issue associated with performance of a task or operation of an application or a device, and determining, based on the analysis of the issue and based on a machine learning based automated incident resolution model, whether the issue is appropriate for automated resolution. If so, automated resolution of the issue may be implemented to resolve the issue. Alternatively, a machine learning based incident classification model may be used to determine whether an incident associated with the issue is actionable or non-actionable. If the incident is actionable, a machine learning based incident ticket creation and routing model may be used to generate an incident ticket associated with the incident, and determine support personnel selected from a plurality of support personnel to resolve the incident ticket.

### BACKGROUND

An incident may result from any type of issue encountered with respect to performance of a task or with respect to operation of an application or a device. For example, in an enterprise environment, a variety of tasks related to operations of an organization may be performed. When an issue is determined with respect to a task, an incident ticket may be created and include a specification of an incident that is to be resolved. Once an incident specified in the incident ticket is resolved, the incident ticket may be closed.

### BRIEF DESCRIPTION OF DRAWINGS

Features of the present disclosure are illustrated by way of example and not limited in the following figure(s), in which like numerals indicate like elements, in which:

FIG. 1 illustrates a layout of a machine learning based incident classification and resolution apparatus in accordance with an example of the present disclosure;

FIG. 2 illustrates reactive and proactive mode flows of the machine learning based incident classification and resolution apparatus of FIG. 1 in accordance with an example of the present disclosure;

FIG. 3 illustrates a recommendation process flow to illustrate operation of the machine learning based incident classification and resolution apparatus of FIG. 1 in accordance with an example of the present disclosure;

FIG. 4 illustrates a sentiment analysis sub-process of the recommendation process flow of FIG. 3 to illustrate operation of the machine learning based incident classification and resolution apparatus of FIG. 1 in accordance with an example of the present disclosure;

FIG. 5 illustrates a key phrases determination sub-process of the recommendation process flow of FIG. 3 to illustrate operation of the machine learning based incident classification and resolution apparatus of FIG. 1 in accordance with an example of the present disclosure;

FIG. 6 illustrates an incident resolution recommendation sub-process of the recommendation process flow of FIG. 3 to illustrate operation of the machine learning based incident classification and resolution apparatus of FIG. 1 in accordance with an example of the present disclosure;

FIG. 7 illustrates an incident knowledge base (KB) article recommendation sub-process of the recommendation process flow of FIG. 3 to illustrate operation of the machine learning based incident classification and resolution apparatus of FIG. 1 in accordance with an example of the present disclosure;

FIG. 8 illustrates an incident nature recommendation sub-process of the recommendation process flow of FIG. 3 to illustrate operation of the machine learning based incident classification and resolution apparatus of FIG. 1 in accordance with an example of the present disclosure;

FIG. 9 illustrates a proactive Bot process to illustrate operation of the machine learning based incident classification and resolution apparatus of FIG. 1 in accordance with an example of the present disclosure;

FIG. 10 illustrates proactive Bot display of result data to illustrate operation of the machine learning based incident classification and resolution apparatus of FIG. 1 in accordance with an example of the present disclosure;

FIG. 11 illustrates a service level agreement flow to illustrate operation of the machine learning based incident classification and resolution apparatus of FIG. 1 in accordance with an example of the present disclosure;

FIG. 12 illustrates a machine learning based predictive model retraining flow to illustrate operation of the machine learning based incident classification and resolution apparatus of FIG. 1 in accordance with an example of the present disclosure;

FIG. 13 illustrates a failure prediction flow to illustrate operation of the machine learning based incident classification and resolution apparatus of FIG. 1 in accordance with an example of the present disclosure;

FIG. 14 illustrates a Level-3 ticket prediction flow to illustrate operation of the machine learning based incident classification and resolution apparatus of FIG. 1 in accordance with an example of the present disclosure;

FIG. 15 illustrates an incident creation and routing flow to illustrate operation of the machine learning based incident classification and resolution apparatus of FIG. 1 in accordance with an example of the present disclosure;

FIG. 16 illustrates an example block diagram for machine learning based incident classification and resolution in accordance with an example of the present disclosure;

FIG. 17 illustrates a flowchart of an example method for machine learning based incident classification and resolution in accordance with an example of the present disclosure; and

FIG. 18 illustrates a further example block diagram for machine learning based incident classification and resolution in accordance with another example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Machine learning based incident classification and resolution apparatuses, methods for machine learning based incident classification and resolution, and non-transitory computer readable media having stored thereon machine readable instructions to provide machine learning based incident classification and resolution are disclosed herein. The apparatuses, methods, and non-transitory computer readable media disclosed herein provide for analysis of an issue associated with performance of a task or operation of an application or a device. Based on the analysis of the issue and based on a machine learning based automated incident resolution model, a determination may be made as to whether the issue is appropriate for automated resolution. If so, automated resolution of the issue may be implemented to resolve the issue. Alternatively, a machine learning based incident classification model may be used to determine whether an incident associated with the issue is actionable or non-actionable. If the incident is actionable, a machine learning based incident ticket creation and routing model may be used to generate an incident ticket associated with the incident, and determine support personnel selected from a plurality of support personnel to resolve the incident ticket. Recommendations that include an incident nature recommendation, an incident resolution recommendation, and an incident knowledge base article recommendation may be generated for the selected support personnel.

With respect to incidents as disclosed herein, according to an example, in an information technology environment, an incident may include, for example, a website shutdown due to an underlying issue of a server malfunction. When an issue is determined, a user may notify appropriate personnel to create an incident ticket that identifies an incident associated with the underlying issue. For example, the incident ticket may be created using incident management tools such as ServiceNow (SNOW), Incident Management (ICM), etc. Personnel in charge of analyzing the incident ticket may attempt to determine a severity or priority of an incident (or underlying issue) specified in the incident ticket. The incident ticket may be thereafter routed to an appropriate location for resolution. In this regard, it is technically challenging to accurately determine a severity or priority of an incident specified in the incident ticket, and to accurately route the incident ticket, as an incorrect assessment may lead to a longer resolution time and/or breach of a service level agreement (SLA).

Incidents specified in an incident ticket may also be actionable or non-actionable. While an actionable incident may require certain actions for resolution, an incident ticket that specifies a non-actionable incident may be closed without further action. However, it is technically challenging to efficiently and accurately determine whether an incident ticket is actionable or non-actionable.

Once an incident ticket is appropriately routed for resolution, aspects such as knowledge base articles, similar historical incidents, etc., may be analyzed to determine a resolution to the incident ticket. The time needed to analyze such knowledge base articles, similar historical incidents, etc., may be detrimental to maintaining specified incident resolution times according to a service level agreement. In this regard, it is technically challenging to determine whether an incident is close to breaching a service level agreement, or whether the incident has already breached the service level agreement.

Yet further, it is technically challenging to predict the occurrence of certain incidents, and to implement a resolution to such incidents absent the actual occurrence of the incidents.

In order to address at least the aforementioned technical challenges, the apparatuses, methods, and non-transitory computer readable media disclosed herein provide for utilization of machine learning based predictive models to provide incident nature, incident resolution, and incident knowledge base article recommendations with respect to an incident. In this regard, occurrence of an incident may be predicted and rectified (e.g., via resolution as disclosed herein) without human intervention before an underlying issue is converted to an incident. Alternatively, an incident ticket may be routed to appropriate support personnel for incident resolution based on analysis of factors such as user sentiment while reporting the incident, noise reduction based on identification of non-actionable incidents, prediction of incidents that may escalate to a high-level (e.g., Level-3 on a scale of 1 to 3, where Level-1 represents low priority, Level-2 represents medium priority, and Level-3 represent high priority), categorization of incidents, and providing of details with respect to opening and closing of incident tickets.

The apparatuses, methods, and non-transitory computer readable media disclosed herein may operate in a reactive mode and/or a proactive mode. In the reactive mode, an indication of an incident (or an issue associated with an incident) that is being experienced by a user may be received. Metadata associated with the incident may be analyzed to generate an incident ticket, and to determine a state (e.g., new or existing) of the incident. If the incident is new, a determination may be made as to whether the incident is actionable or non-actionable. This determination may be made by utilizing a machine learning based incident classification model that is trained on historical incident tickets, where each such historical incident tickets may be labeled as actionable or non-actionable. Thus, the machine learning based incident classification model may be utilized to determine a type of an incident ticket, and to take action such as closure of the incident ticket in the event of a non-actionable ticket, as well as prediction of a nature of the incident ticket. If the incident ticket is an actionable incident ticket, a machine learning based incident ticket creation and routing model may be utilized to determine appropriate routing information for the incident ticket. In this regard, the machine learning based incident ticket creation and routing model may learn incident ticket routing patterns from historical incident ticket assignments, and determine a correct assignment group for a new incident ticket based on prior assignment of similar incident tickets for the assigned group.

An issue may be analyzed to determine whether it is an appropriate candidate for automated resolution (e.g., resolution without human intervention). For example, permission related issues, issues related to high memory consumption, or any issue for which resolution steps are present may be an appropriate candidate for automated resolution. In this regard, resolution as disclosed herein may be a configurable process that includes an indication of whether a process or a component may include a set of parameters that are appropriate for resolution of a potential incident. If the issue (or associated potential incident) is determined to be appropriate for resolution, once the specified resolution steps have been implemented, a determination may be made as to whether an underlying issue associated with a potential incident is resolved, and if so, the associated incident ticket may not need to be generated (or may indicate closure without the occurrence of an incident).

With respect to the aforementioned recommendation process that includes incident nature recommendation, incident resolution recommendation, and incident knowledge base article recommendation, these recommendations may be utilized by appropriate personnel to resolve an incident. Generally, the incident nature recommendation may specify the nature or the category of an incident (e.g., whether in an incident is a login related issue, or a memory related issue). An incident resolution recommendation may specify details of similar historical incidents that may be referred to for solving a current incident. An incident knowledge base article recommendation may provide details of knowledge base articles that may be referred to for solving a current incident. In this regard, metadata with respect to an incident may be analyzed to determine key words. For example, the MICROSOFT prebuilt Cognitive application programming interface specified as Text Analytics Key Phrase may be utilized to determine key phrases and keywords. The key words may be used to determine a user sentiment score, with respect to a user that has identified the incident. For example, the MICROSOFT prebuilt Cognitive application programming interface specified as Text Analytics Sentiment may be utilized to determine a sentiment score. The incident metadata may be further analyzed to determine historical and knowledge base recommendations. These recommendations may be sorted based on relevance. The incident nature recommendation may be determined, for example, by using a machine learning based incident nature model to predict various incident features such as incident category, subcategory, assignment group, application name, severity, etc., based on the historical incident information. Incident category may represent the high-level categorization of incident tickets that is aligned with an organization, such as, “application and service”, “infrastructure and network”, etc. Incident subcategory may represent a next level categorization that represents a type of an incident ticket, such as, “configuration”, “functionality”, “data missing”, etc. Assignment group may represent a group of people that may be assigned to an incident for resolution of the incident. Severity of an incident may represent a categorization of incidents based on impact, such as severity-1, severity-2, severity-3, etc.

With respect to determining whether an incident ticket may be escalated to a high-level (e.g., Level-3 on a scale of 1 to 3, where Level-1 represents low priority, Level-2 represents medium priority, and Level-3 represent high priority) for resolution, Level-3 (also referred to as Line-3) personnel may be proactive in nature, identify issues in advance, and look for continuous service improvement opportunities. If a resolution involves enhancements and development related to a product or process that is involved in the incident, the incident ticket may be further transferred to Level-4 engineering and development personnel. Since an incident ticket that may be transferred to Level-3 or Level-4 personnel may first go through Level-1 and Level-2 support, the necessary time and resources may be expended for resolution of such an incident ticket. In this regard, a determination may be made as to whether an incident ticket qualifies, for example, for Level-3 or Level-4 support by using a machine learning based incident ticket creation and routing model that may be trained on historical incident tickets that qualified for such Level-3 or Level-4 support.

As disclosed herein, the apparatuses, methods, and non-transitory computer readable media disclosed herein may operate in a reactive mode and/or a proactive mode. In the proactive mode, resolution of an incident ticket may include implementation of a proactive Bot, automated (e.g., without human intervention) resolution of an issue prior to occurrence of an incident, automated retraining, and failure prediction.

With respect to failure prediction, the apparatuses, methods, and non-transitory computer readable media disclosed herein may predict failure with respect to a task, an application, or a device prior to occurrence of an incident. In this regard, parameters such as application logs may be monitored for errors and warnings, application infrastructure logs may be monitored for abnormal activities such as memory spikes, disk utilization spikes, etc., and application usage patterns that lead to a warning or an error. This information may be fed to a machine learning based automated incident resolution model that has been continuously trained or historical data that led to the creation of incidents. When the machine learning based automated incident resolution model predicts that the information supplied to it is a potential candidate of turning into an incident, a determination may be made as to whether automated resolution has been configured to resolve this scenario. This determination may be made on the basis of incidents whose resolution steps (e.g., extensive configuration based solution mapping based on the incident number and incident description) are known, and the apparatus as disclosed herein is capable of solving the incident without human intervention. If automated resolution has indeed been configured to resolve this scenario, the resolution steps may be implemented as disclosed herein to avoid the incident. The avoided incident information may be related to a configured channel. If the automated resolution configuration is not present for the type of incident that is predicted, then this information may be related to the configured channel to take preventative actions. A configured channel may be created, for example, in MICROSOFT Teams under a directory for users who are included as part of the configured channel, where such users may include the authority to work on an incident.

In order to ensure that the various machine learning based predictive models are up to date, the models may be continuously evaluated and retrained with the latest data. Thus the machine learning based predictive models may be referred to as continuous learning models. The continuous evaluation and retraining of the machine learning based addictive models may ensure that the prediction results include high accuracy.

Once an incident is logged, and aspects such as recommendations, sentiment scores, and predictions have been determined, a proactive Bot may post associated data to configured channels that have the correct set of members to start working on an incident. The associated data may also be posted to a configured set of individual users. In this regard, the proactive Bot may collect user feedback on the usefulness of the machine learning based predictions. Further, the proactive Bot may listen to incoming messages, and relay the messages to the relevant channels based on pre-specified assignments.

A service level agreement dashboard feature may provide information related to active incidents, as well as aspects such as updated user sentiment score, service level agreement, etc., in real time. An actual service level agreement compliance may be determined based on incident severely and duration, and service level agreement breach may be determined using associated service level agreement data such as severely, incident duration, and time allotted for resolving the incident. According to an example, service level agreement hours may be determined based on the severity of an incident. For example, if the severity is three (e.g., urgent), then the service level agreement time may be fixed at 24 hours. If the severity is four (e.g., standard), then the service level agreement time may be fixed at 72 hours. Further, the total active hours of the incident may be subtracted from the service level agreement time to obtain the exact service level breach time. The incident information along with service level agreement and sentiment score may be displayed, and this information may be updated in real time to ensure that the user is not acting on outdated data.

For the apparatuses, methods, and non-transitory computer readable media disclosed herein, the elements of the apparatuses, methods, and non-transitory computer readable media disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

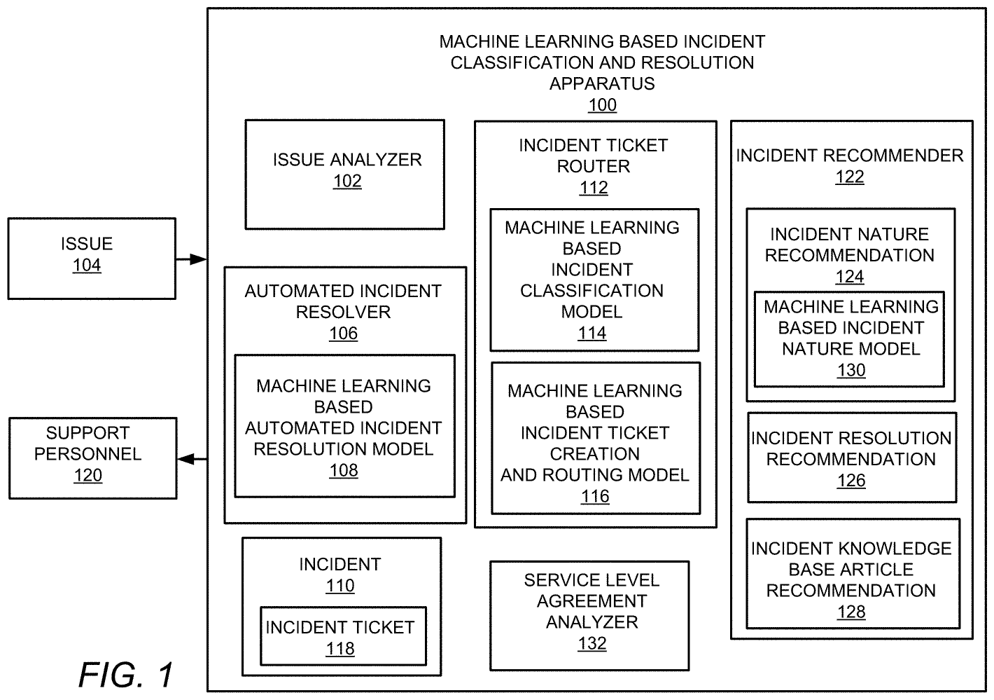

FIG. 1 illustrates a layout of an example machine learning based incident classification and resolution apparatus (hereinafter also referred to as “apparatus 100”).

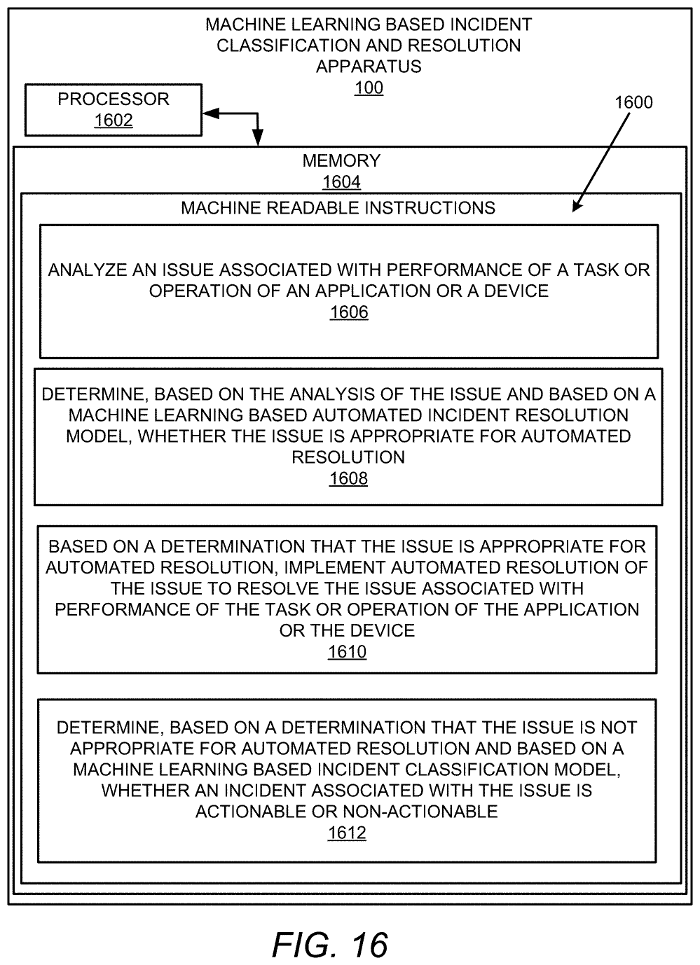

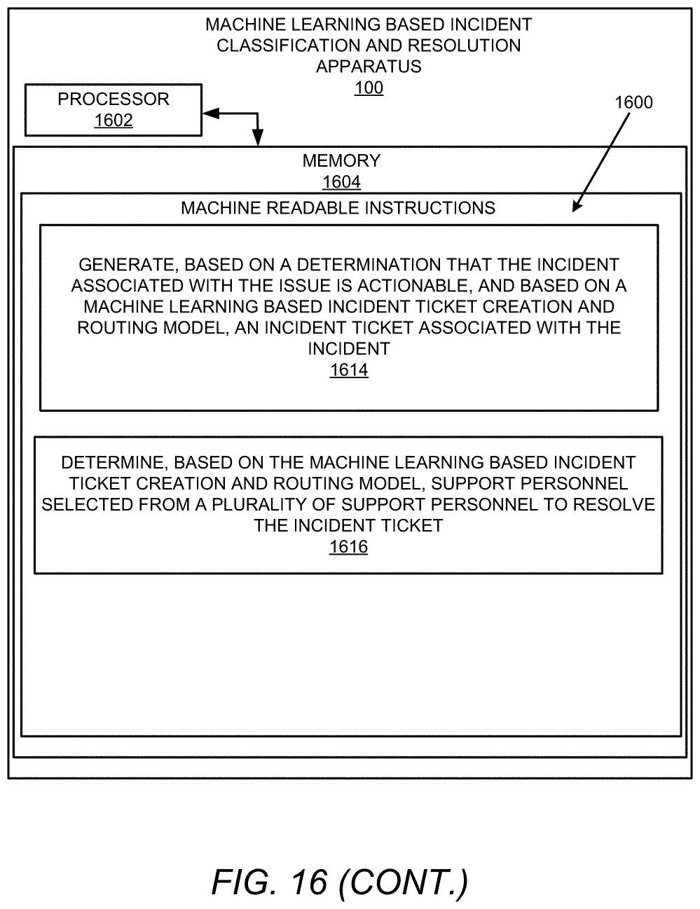

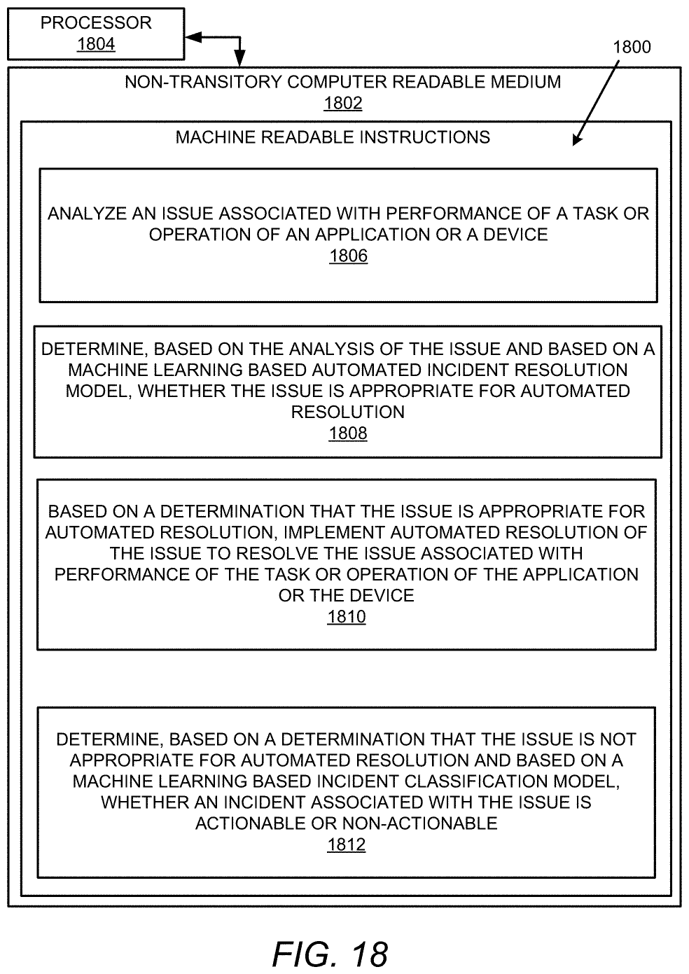

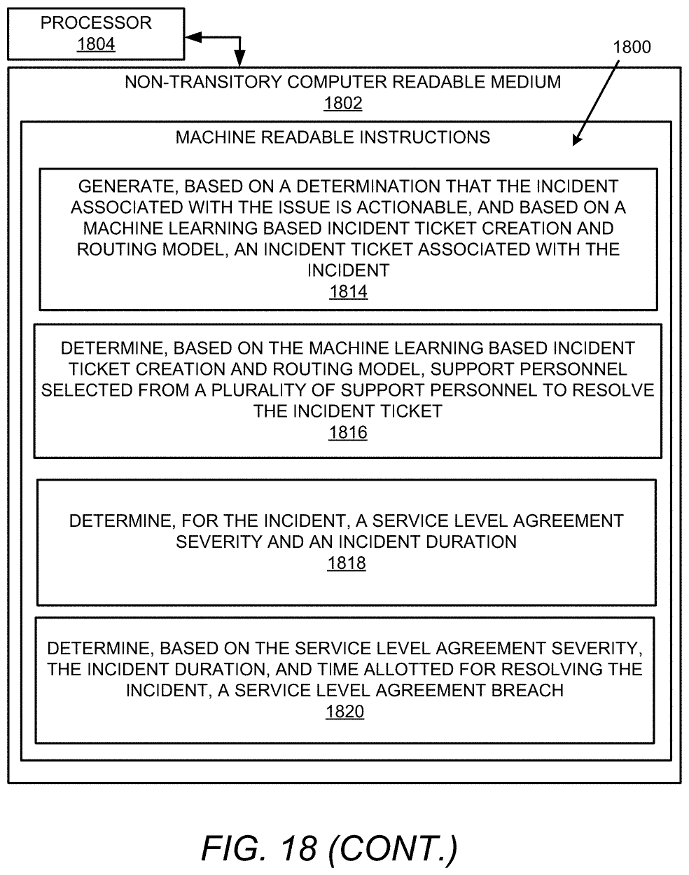

Referring to FIG. 1, the apparatus 100 may include an issue analyzer 102 that is executed by at least one hardware processor (e.g., the hardware processor 1602 of FIG. 16, and/or the hardware processor 1804 of FIG. 18) to analyze an issue 104 associated with performance of a task or operation of an application or a device.

An automated incident resolver 106 that is executed by at least one hardware processor (e.g., the hardware processor 1602 of FIG. 16, and/or the hardware processor 1804 of FIG. 18) may determine, based on the analysis of the issue 104 and based on a machine learning based automated incident resolution model 108, whether the issue 104 is appropriate for automated resolution. Based on a determination that the issue 104 is appropriate for automated resolution, the automated incident resolver 106 may implement automated resolution of the issue 104 to resolve the issue 104 associated with performance of the task or operation of the application or the device.

According to examples disclosed herein, the automated incident resolver 106 may determine, based on the analysis of the issue 104 and based on the machine learning based automated incident resolution model 108, whether the issue 104 is appropriate for automated resolution by determining, based on the analysis of the issue 104 that includes, for example, memory spikes, disk utilization spikes, and/or anomalous application usage patterns, and based on the machine learning based automated incident resolution model 108, whether the issue 104 includes a potential to turn into an incident 110. Further, based on a determination that the issue 104 includes the potential to turn into the incident 110, the automated incident resolver 106 may determine, based on the machine learning based automated incident resolution model 108, whether the issue 104 is appropriate for automated resolution.

An incident ticket router 112 that is executed by at least one hardware processor (e.g., the hardware processor 1602 of FIG. 16, and/or the hardware processor 1804 of FIG. 18) may determine, based on a determination that the issue 104 is not appropriate for automated resolution and based on a machine learning based incident classification model 114, whether the incident 110 associated with the issue 104 is actionable or non-actionable. The incident ticket router 112 may generate, based on a determination that the incident 110 associated with the issue 104 is actionable, and based on a machine learning based incident ticket creation and routing model 116, an incident ticket 118 associated with the incident 110. The incident ticket router 112 may determine, based on the machine learning based incident ticket creation and routing model 116, support personnel 120 selected from a plurality of support personnel to resolve the incident ticket 118.

According to examples disclosed herein, the incident ticket router 112 may determine, based on the machine learning based incident ticket creation and routing model 116, support personnel 120 selected from a plurality of support personnel to resolve the incident ticket 118 by training, based on historical incident tickets that qualify for high level support, the machine learning based incident ticket creation and routing model 116. The incident ticket router 112 may determine, based on the trained machine learning based incident ticket creation and routing model 116, whether the incident ticket 118 qualifies for the high level support. Further, based on a determination that the incident ticket 118 qualifies for the high level support, the incident ticket router 112 may determine the support personnel 120 associated with the high level support to resolve the incident ticket 118.

According to examples disclosed herein, the incident ticket router 112 may determine, based on the trained machine learning based incident ticket creation and routing model 116, whether the incident ticket 118 qualifies for the high level support by identifying, based on the trained machine learning based incident ticket creation and routing model 116, clusters of historical incidents that are similar to the incident 110. The incident ticket router 112 may identify incidents, from the identified clusters of historical incidents, which share a pattern with the incident 110. Further, the incident ticket router 112 may determine, based on an analysis of the pattern and a degree of association between the identified incidents and the incident 110, whether the incident ticket 118 qualifies for the high level support.

According to examples disclosed herein, the incident ticket router 112 may determine, based on the determination that the issue 104 is not appropriate for automated resolution and based on the machine learning based incident classification model 114, whether the incident 110 associated with the issue 104 is actionable or non-actionable by comparing, based on the machine learning based incident classification model 114, the incident 110 to historical incidents to determine whether the incident 110 associated with the issue 104 is actionable or non-actionable.

An incident recommender 122 that is executed by at least one hardware processor (e.g., the hardware processor 1602 of FIG. 16, and/or the hardware processor 1804 of FIG. 18) may generate, for the selected support personnel 120, recommendations that include an incident nature recommendation 124, an incident resolution recommendation 126, and an incident knowledge base article recommendation 128.

According to examples disclosed herein, the incident recommender 122 may generate, for the selected support personnel 120, the incident nature recommendation 124 by ascertaining incident data for the incident 110. The incident recommender 122 may analyze the incident data by a trained machine learning based incident nature model 130. Further, the incident recommender 122 may determine, based on the analysis of the incident data by the trained machine learning based incident nature model 130, the incident nature recommendation 124.

According to examples disclosed herein, the incident recommender 122 may generate, for the selected support personnel 120, the incident resolution recommendation 126 by generating incident metadata for the incident 110. The incident recommender 122 may determine, based on the incident metadata, key phrases associated with the incident 110. The incident recommender 122 may determine, based on the key phrases associated with the incident 110, a historical incident, from a plurality of historical incidents, which includes a high confidence score based on a match to the incident 110. Further, the incident recommender 122 may determine, based on the historical incident, the incident resolution recommendation 126.

According to examples disclosed herein, the incident recommender 122 may generate, for the selected support personnel 120, the incident knowledge base article recommendation 128 by generating incident metadata for the incident 110. The incident recommender 122 may determine, based on the incident metadata, key phrases associated with the incident 110. The incident recommender 122 may determine, based on the key phrases associated with the incident 110, a knowledge base article, from a plurality of knowledge base articles, which includes a high confidence score based on a match to the incident 110. Further, the incident recommender 122 may determine, based on the knowledge base article, the incident knowledge base article recommendation 128.

A service level agreement analyzer 132 that is executed by at least one hardware processor (e.g., the hardware processor 1602 of FIG. 16, and/or the hardware processor 1804 of FIG. 18) may determine, for the incident 110, a service level agreement severity and an incident duration. The service level agreement analyzer 132 may determine, based on the service level agreement severity, the incident duration, and time allotted for resolving the incident 110, a service level agreement breach.

Operation of the apparatus 100 is described in further detail with reference to FIGS. 1-15.

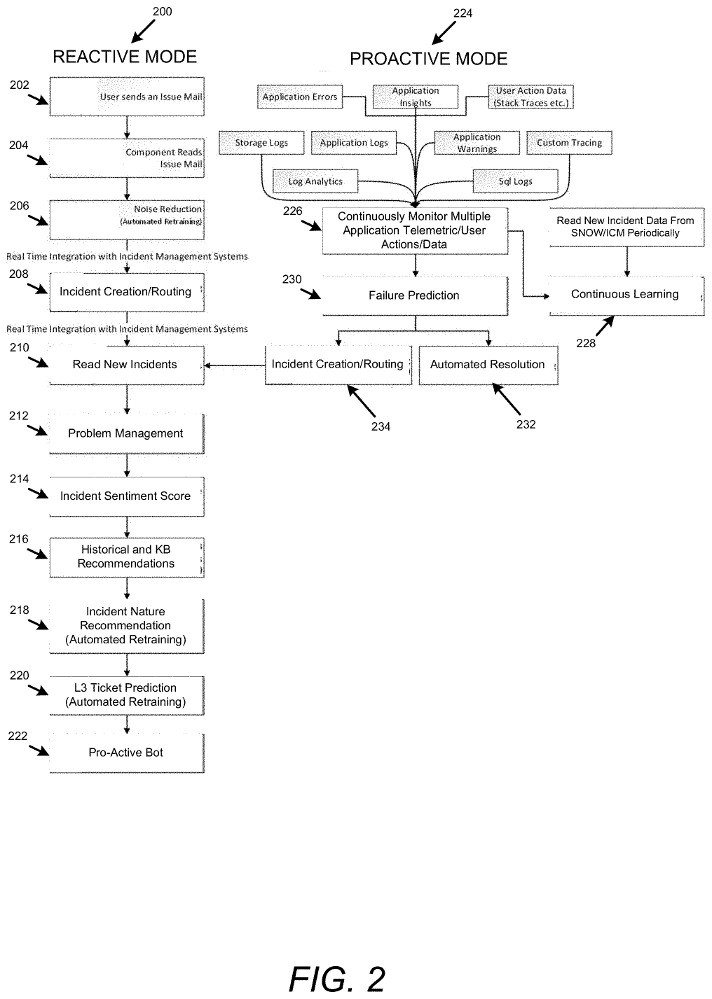

FIG. 2 illustrates reactive and proactive mode flows of the machine learning based incident classification and resolution apparatus of FIG. 1 in accordance with an example of the present disclosure.

Referring to FIG. 2, the reactive mode 200 may commence at 202 with a user sending a notification, for example, to the issue analyzer 102 at 204.

At block 206, noise reduction may be performed as disclosed herein for identification of actionable and non-actionable incidents.

At block 208, the incident ticket router 112 may generate a new incident ticket.

At block 210, new incidents may be analyzed, and at block 212, each time an incident ticket is created on a problem management tool, for example, Service NOW, this information may be stored in a relational database.

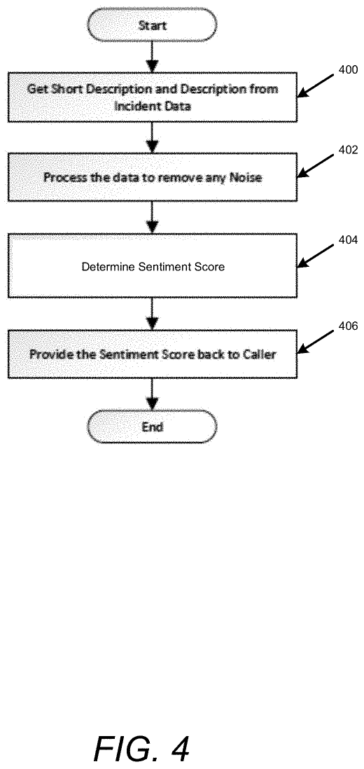

At block 214, an incident sentiment score may be determined as disclosed herein with reference to FIG. 4.

At block 216, the incident recommender 122 may generate the incident resolution recommendation 126, and the incident knowledge base article recommendation 128.

At block 218, the incident recommender 122 may generate the incident nature recommendation 124.

At block 220, the incident ticket router 112 may determine whether an incident ticket is suitable for Level-3 support as disclosed herein.

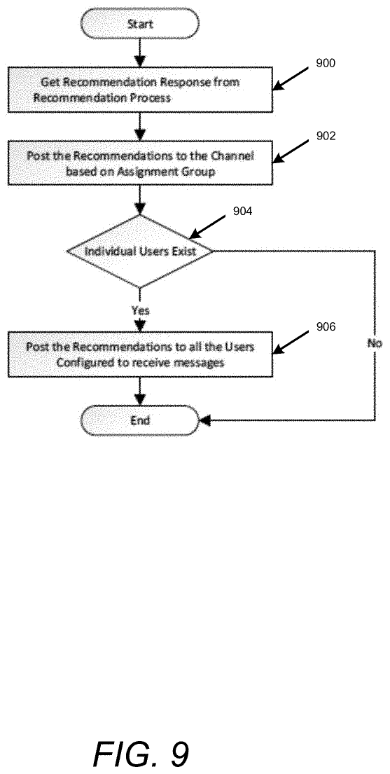

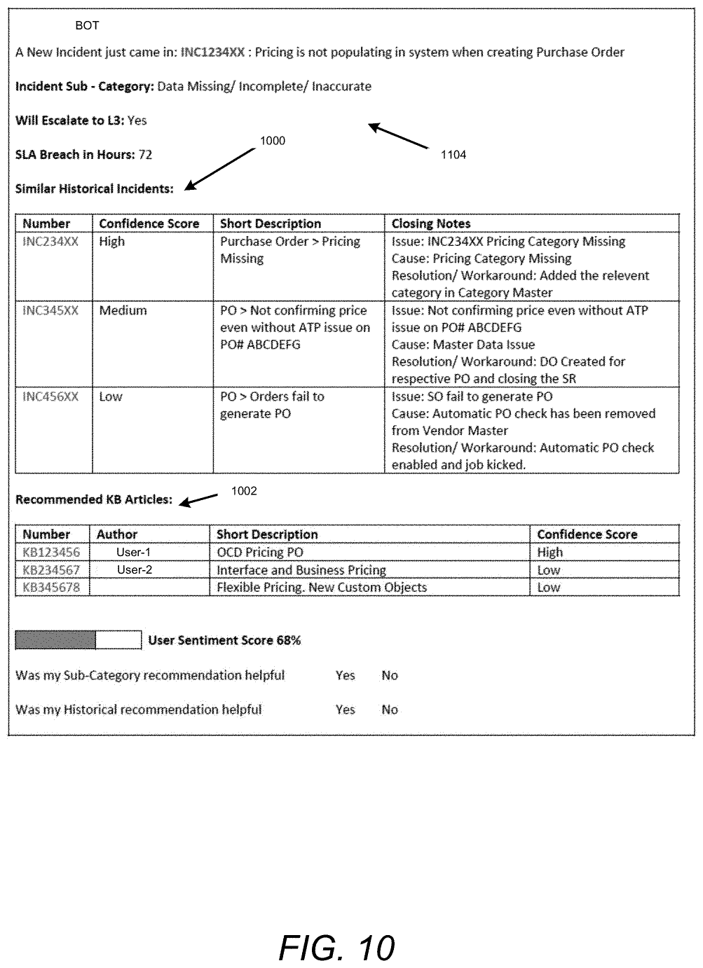

At block 222, operation of the proactive Bot is performed as disclosed herein with reference to FIGS. 9 and 10.

With respect to the proactive mode at 224, at block 226, the automated incident resolver 106 may determine whether an issue is appropriate for automated resolution by determining, based on the analysis of the issue that includes, for example, memory spikes, disk utilization spikes, and/or anomalous application usage patterns, and based on the machine learning based automated incident resolution model 108, whether the issue includes a potential to turn into an incident.

At block 228, continuous learning may be utilized as disclosed herein for training of the various machine learning based predictive models to ensure that the prediction results include high accuracy.

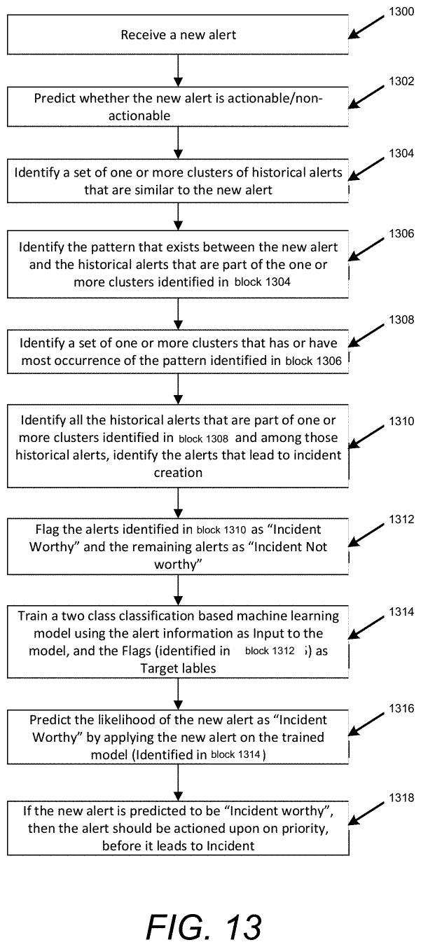

At block 230, failure prediction may be performed as disclosed herein with respect to FIG. 13.

At block 232, the automated incident resolver 106 may implement automated resolution of an issue to resolve the issue associated with performance of the task or operation of the application or the device.

At block 234, if automated incident resolution is not performed at block 232 (e.g., the issue is not suitable for automated resolution), processing may proceed to block 210 after an incident is created and routed to block 210.

Incident Nature Recommendation, Incident Resolution Recommendation, and Incident Knowledge Base Article Recommendation

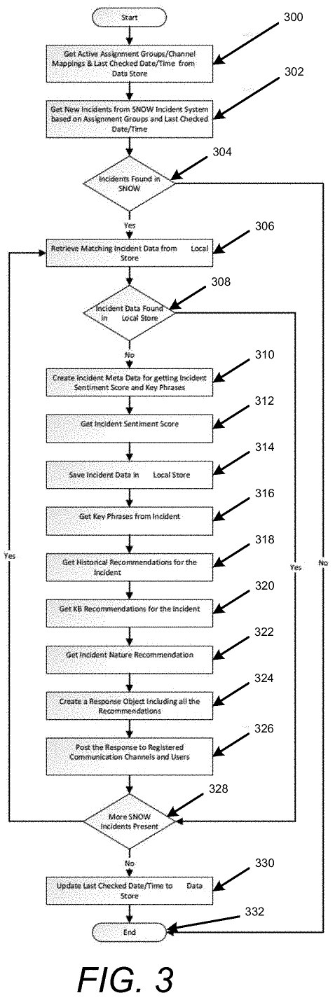

Referring again to FIG. 1, as disclosed herein, the incident recommender 122 may generate an incident nature recommendation 124, an incident resolution recommendation 126, and an incident knowledge base article recommendation 128. In this regard, the incident recommender 122 may ascertain active assignment groups and channel mappings from a data store (not shown). Assignment groups may be used as a filter criterion for fetching incidents, and channel mappings may be used while pushing a final response object to a user. For example, FIG. 3 illustrates a recommendation process flow to illustrate operation of the apparatus 100 in accordance with an example of the present disclosure.

Referring to FIG. 3, at blocks 300 and 302 of FIG. 3, last checked date/time may be utilized as a filter criterion while fetching incidents (or incident tickets). If incidents matching the filter criterion exist, then matching incident data may be retrieved from the data store (not shown). This analysis may facilitate a determination of whether an incident has already been processed or not. Incidents that have already been processed may be discarded, thus resulting in a set of unprocessed incidents that may be subject to further analysis. In this regard, unprocessed incidents may be iterated in parallel to determine recommendations that are relevant to such incidents.

At block 304, if no new incidents are ascertained, processing may proceed to block 332.

At block 306, matching incident data may be retrieved from the data store.

At block 308, a determination may be made as to whether incident data is found in the data store.

If no incident data is found in the data store, at block 310, incident metadata may be generated for obtaining incident sentiment score and key phrases as disclosed herein.

At block 312, the incident sentiment score may be obtained as disclosed herein with respect to FIG. 4.

At block 314, incident data may be stored in the data store.

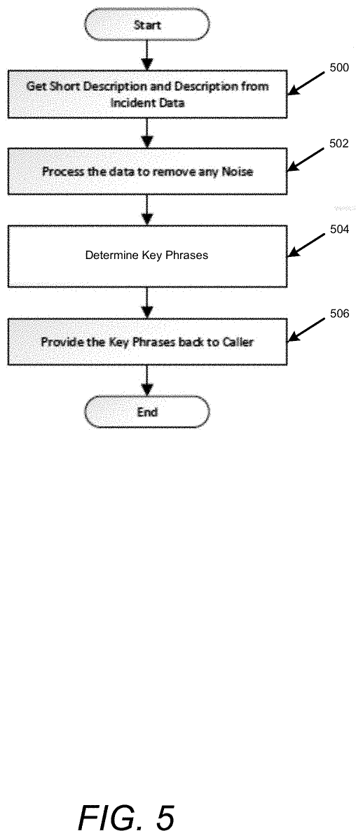

At block 316, key phrases may be obtained from the incident as disclosed herein with respect to FIG. 5.

At block 318, an incident resolution recommendation 126 may be obtained for the incident.

At block 320, an incident knowledge base article recommendation 128 may be obtained for the incident.

At block 322, an incident nature recommendation 124 may be obtained for the incident.

At block 324, a response object may be created and include the recommendations that include the incident nature recommendation 124, the incident resolution recommendation 126, and the incident knowledge base article recommendation 128.

At block 326, the associated response may be posted to the appropriate communication channels and users.

At block 328, a determination may be made as to whether additional incidents are present.

At block 330, last checked date/time information may be updated in the data store.

As disclosed herein, unprocessed incidents may be iterated in parallel to determine recommendations relative to such incidents. In this regard, a first step in the iteration process may include obtaining an incident sentiment score. FIG. 4 illustrates a sentiment analysis sub-process of the recommendation process flow of FIG. 3 to illustrate operation of the apparatus 100 in accordance with an example of the present disclosure.

Referring to FIG. 4, at block 400, a description and short description for the incident that is being analyzed may be obtained from incident data.

At block 402, the data received at block 400 may be processed to remove noise. For example, features such as special characters, unnecessary spaces, etc., may be removed.

At block 404, the sentiment score may be determined for the data processed at block 402.

At block 406, the sentiment score determined at block 404 may be provided back to the caller (e.g., the user or another entity that requested the sentiment score).

The new incident data may be saved to the data store (not shown) to ensure that this data is not processed again in subsequent processes related to associated incidents. Thereafter, incident key phrases may be determined. For example, FIG. 5 illustrates a key phrases determination sub-process of the recommendation process flow of FIG. 3 to illustrate operation of the apparatus 100 in accordance with an example of the present disclosure.

Referring to FIG. 5, at block 500, the description and short description for the incident that is being analyzed may be obtained from incident data.

At block 502, the data received at block 500 may be processed to remove noise. For example, features such as special characters, unnecessary spaces, etc. may be removed.

At block 504, the key phrases may be determined for the data processed at block 502.

At block 506, the key phrases determined at block 504 may be provided back to the caller (e.g., the user or another entity that requested the sentiment score).

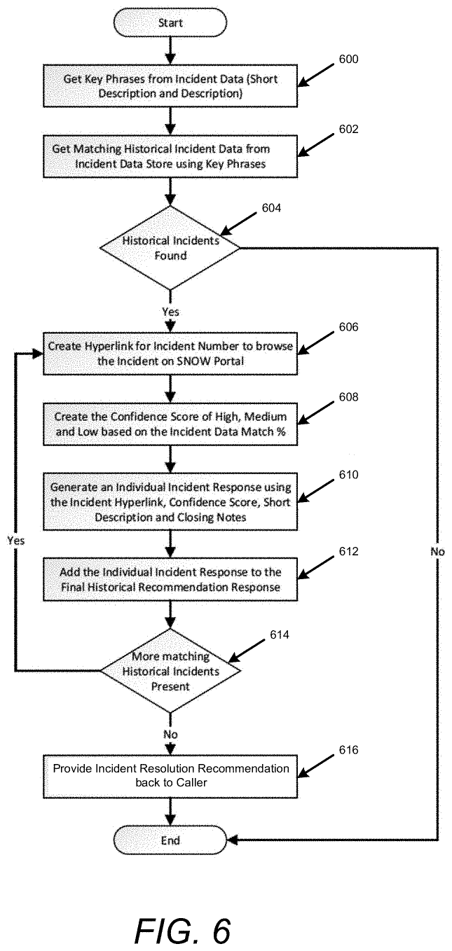

Referring again to FIG. 1, as disclosed herein, the incident recommender 122 may generate an incident nature recommendation 124, an incident resolution recommendation 126, and an incident knowledge base article recommendation 128. With respect to the incident resolution recommendation 126, FIG. 6 illustrates an incident resolution recommendation sub-process of the recommendation process flow of FIG. 3 to illustrate operation of the apparatus 100 in accordance with an example of the present disclosure.

Referring to FIG. 6, the incident resolution sub-process may obtain key phrases obtained, for example, as disclosed herein with respect to FIG. 5. For example, at 600, key phrases for the incident under analysis may be supplied to the incident recommender 122 that is configured to obtain the data from a data store (not shown). The data store may be refreshed with incident data on a scheduled interval. If matching results are found in the data store, then these results may be iterated to create an individual incident response that is added to the final incident resolution recommendation response.

For example, at block 602, matching historical incident data may be obtained from the data store using the key phrases (for the incident under analysis) obtained at block 600.

At block 604, a determination may be made as to whether historical incidents are found.

At block 606, a hyperlink may be created for an incident number to browse the incident.

At block 608, a confidence score of high, medium, and low may be created based on incident match percentage, for example, to the incident under analysis.

At block 610, an individual incident response may be generated using the incident hyperlink, confidence score, short description, and closing notes.

At block 612, the individual incident response may be added to the final incident resolution recommendation 126 response.

At block 614, a determination may be made as to whether additional matching historical incidents are present.

At block 616, the incident resolution recommendation 126 may be provided back to the caller (e.g., the user or another entity that requested this information). The incident resolution recommendation 126 may include relevant historical incidents determined at blocks 606-612.

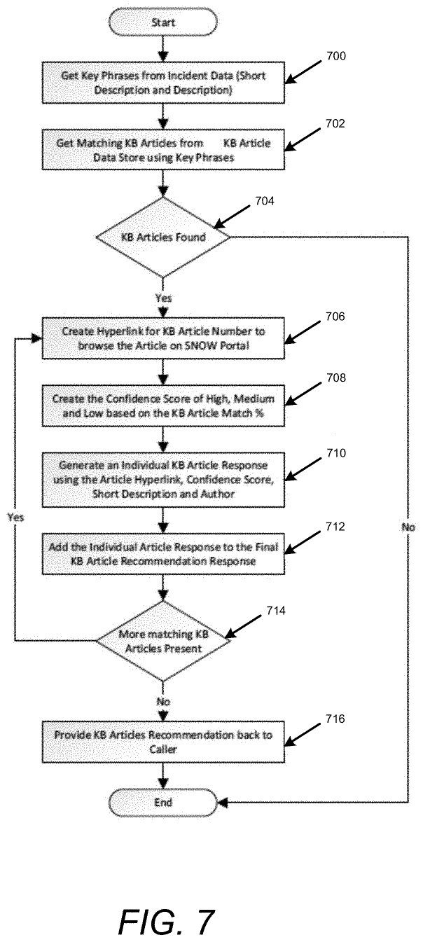

With respect to determination of incident knowledge base article recommendation 128 by the incident recommender 122, FIG. 7 illustrates an incident knowledge base (KB) article recommendation sub-process of the recommendation process flow of FIG. 3 to illustrate operation of the apparatus 100 in accordance with an example of the present disclosure.

Referring to FIG. 7, the knowledge base article recommendation sub-process may obtain recommendations based on the key phrases determined in FIG. 5.

At block 700, key phrases may be supplied to the incident recommender 122 that is configured to find the data from a data store (not shown). This data store may be refreshed with knowledge base data on a scheduled interval. If the matching results are found in the data store, the matching results may be iterated to create an individual incident response that is added to the final knowledge base recommendation response.

At block 702, matching knowledge base articles may be obtained from the knowledge base article data store (not shown) using the key phrases obtained at block 700.

At block 704, a determination may be made as to whether knowledge base articles are found.

At block 706, based on a determination at block 704 that knowledge base articles are found, a hyperlink may be created for the knowledge base article number to browse the article.

At block 708, a confidence score of high, medium, and low may be created based on the knowledge base article match percentage, for example, to the incident under analysis.

At block 710, an individual knowledge base article response may be generated using the article hyperlink, confidence score, short description, and author.

At block 712, the individual article response may be added to the final knowledge base article recommendation response.

At block 714, a determination may be made as to whether there are additional matching knowledge base articles present.

At block 716, the incident knowledge base article recommendation 128 may be provided back to the caller (e.g., the user or entity that requested this information).

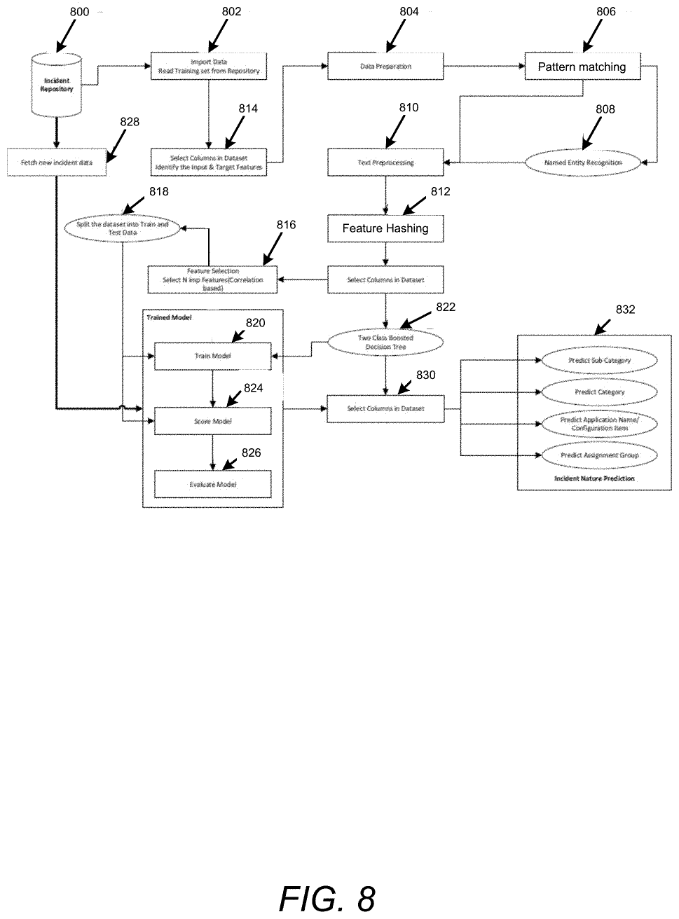

With respect to determination of incident nature recommendation 124 by the incident recommender 122, FIG. 8 illustrates an incident nature recommendation sub-process of the recommendation process flow of FIG. 3 to illustrate operation of the apparatus 100 in accordance with an example of the present disclosure.

Referring to FIG. 8, with respect to block 800, each time an incident (e.g., the incident 110) is created by the issue analyzer 102, this information may be stored in a relational database (not shown). Information related to an incident, such as, description and other technical details may be stored in the relational database. In this regard, historical incident information may be utilized in training the machine learning based incident nature model 130 as disclosed herein.

At block 802, the incident information may be pulled from the incident repository at block 800 to a temporary working environment, which may be a cloud storage or a local machine. This step may ensure that all information needed to perform machine learning is locally available at one location, thereby reducing overall execution time.

At block 804, a determination may be made as to whether any of the input or output features associated with the incident 110 include missing or NULL values. In this regard, the presence of missing values may affect prediction accuracy of the machine learning based incident nature model 130, and thus the missing values may be treated by either removing the entire data point from the training data set or replacing the missing value with mean or median of that feature. For example, assuming that a feature that represents a height of a person includes multiple missing values, a strategy to address the missing values for the height feature may include replacing all of the missing values with the mean of the height of the remaining individuals for whom there are values. The missing value treatment strategy that is utilized may be determined based on the volume of the training data. For example, if there are more than 5000 records, the entire data point may be removed from the training data set, and otherwise the missing value may be replaced with mean or median of that feature.

At block it 806, the incident 110 may include limited information such as description and short description that may be in textual form. This textual information may be cleaned by performing pattern matching through regular expression (regex) commands, for example, that may be available in R. For example, assuming that text includes an e-mail address along with other information, and e-mail addresses are not useful information, the e-mail addresses may be removed from the text using a regex command as follows: gsub(“\\w*@\\w*\\. \\w*”, “ ”, data$textfeature).

At block 808, entities such as people, location, organization, etc., that are present in English text for the incident 110 may be recognized. In this regard, a named entity recognition technique may be utilized to determine the proper names present in text. This technique may facilitate the location and categorization of named entity mentions in unstructured text into pre-defined categories such as person names, organizations, locations, medical codes, time expressions, quantities, monetary values, percentages, etc. Since the names of people, organizations, or locations may add noise to the prediction, such words may be eliminated as they include limited predictive qualities.

At block 810, text for the incident 110 may be preprocessed, for example, by stop words removal, lemmatization, stemming, normalizing of cases to lowercase, expansion of verb contractions, split tokens based on special characters, number removal, removal of uniform resource locators, removal of special characters, removal of email addresses, removal of duplicate characters, etc. The preprocessing of the text may facilitate creation of meaningful features from the text.

At block 812, feature hashing may be performed to represent text documents that are associated with the incident 110 and include a variable length as numeric feature vectors of equal length, and to achieve dimensionality reduction. Feature hashing may represent a space-efficient technique of vectorizing features (e.g., turning arbitrary features into indices in a vector or matrix). Feature hashing may include the application of a hash function on a stream of English text, and using the hash values as indices directly to generate numeric feature vectors. In this regard, a technique such as Vowpal-Wabbit may be utilized to transform textual features into binary features using a hashing process to return a hashed feature for each sentence of n-words (N-gram).

At block 814, features which are labeled as input features and target (or output) feature may be selected for the machine learning based incident nature model 130. In this regard, since supervised machine learning is being performed, the target feature may need to be defined, because based on the type of target feature, there may be two types of learning such as continuous feature-based regression learning, or discrete feature based classification learning. In machine learning, a target feature may represent an output of a model.

At block 816, feature selection may be performed, since all of the hashed features returned at block 812 may include high predictive power. In this regard, statistical tests may be applied on the hashed features to measure the feature significance, which may facilitate a ranking of the hashed features based on their predictive power. Feature selection may represent a process of selecting a subset of relevant, useful features to use for building the machine learning based incident nature model 130. Feature selection may narrow the field of data to the most valuable inputs. Narrowing the field of data may reduce noise and improve training performance. Thus, feature selection may facilitate the identification of relevant features that have high predictive power.

At block 818, the data set may be divided into two parts, with a first part including training data, and a second part including test data in a ratio, for example, of 7:3, respectively. The intuition behind this division may be to train the machine learning based incident nature model 130 on a higher chunk of the data set, while retaining a significant portion of the data set for model evaluation. Moreover, this may also ensure that the training and test data sets are mutually exclusive.

At block 820, the machine learning based incident nature model 130 may be trained using the data divided at block 818 into training data and test data. The machine learning based technique selected at block 822 may need to be defined to learn the patterns that exist between the input and output features. For example, a description of the incident, a short description of the incident, and a category of the incident may be utilized as input features to predict a subcategory of the incident. In this regard, the subcategory of the incident may be the output feature of the machine learning based incident nature model 130.

At block 822, the machine learning based technique that is to be applied on data for learning the patterns between input and output features may be selected. In this regard, since a classification supervised learning is being performed, a two class boosted decision tree technique may be used for learning the patterns. The two class boosted decision tree technique may provide high classification accuracy, as disclosed herein with respect to block 826. A boosted decision tree may represent an ensemble learning method in which the second tree corrects for the errors of the first tree, the third tree correct for the errors of the first and second trees, and so forth. Predictions may be based on the entire ensemble of trees together that makes the prediction. A two-class boosted decision model may mean that an output of the model (e.g., target feature) may include two discrete values.

At block 824, the machine learning based incident nature model 130 trained at block 820 may be evaluated, and the associated learning may be scored by applying the machine learning based incident nature model 130 on new unseen test data obtained at block 818. As the past data includes actual target values and the predicted target values need to be determined at block 824, these two types of information may be used to estimate learning performance.

At block 826, the machine learning based incident nature model 130 learning performed at block 824 may be evaluated utilizing statistical tools. This evaluation may be used to determine how the learning has occurred, and how learning performance may be approved for different machine learning based predictive models. While performing supervised classification learning, statistics used to score the machine learning based incident nature model 130 may include Confusion Matrix, Sensitivity, Specificity, receiver operating characteristics (ROC) curve, F1 score, etc. Based on the overall performance of the different techniques that fit to the problem, the techniques may be finalized at block 822.

At block 828, new incident data may be fetched from the incident repository (not shown), where the nature of the incident data is not known and may need to be predicted. The new incident data may be exposed to the trained machine learning based incident nature model 130 to predict results.

At block 830, the incident features predicted at block 828 may be consolidated. Further, the consolidated features may be generated as the incident nature recommendation 124 at block 832.

Once the aforementioned recommendations that include the incident nature recommendation 124, the incident resolution recommendation 126, and the incident knowledge base article recommendation 128 are obtained, a response object may be generated and passed to a registered user and/or channel. In this regard, a user may receive a pop-up with all of the recommendations without any service level agreement time wastage.

Proactive Bot

FIG. 9 illustrates a proactive Bot process to illustrate operation of the apparatus 100 in accordance with an example of the present disclosure.

After an incident is logged and the aforementioned recommendations, sentiment scores, and predictions are determined, the proactive Bot may post all of this data to the configured set of channels and/or users. For example, referring to FIG. 9, as illustrated at 900, a recommendation response may be ascertained from the recommendation process disclosed herein with respect to FIG. 3.

At block 902, the channels may be determined based on the assignment groups predicted by the machine learning based incident ticket creation and routing model 116. An assignment group may represent, for example, a team (e.g., the support personnel 120) that will be assigned to an incident for its resolution. This ensures appropriate routing of the incident data so that the incident data reaches the correct location for further action. Channels may be configured as follows:

| Assignment Group | | |
|---|---|---|
| Name | Assignment Group ID | Team Channel ID |
| Service Redacted | b96b96bcdbRedacted3f1051d96190b | 19:58030cfd7Redacted4392b5d1f@thread.skype |
| Chain | | |
| Service Redacted | 349b141dRedacted9750a8dc961954 | 19:c508afc33Redactedb72a40d27@thread.skype |
| MAX Redacted | | |
| Chain | | |

At block 904, a determination may be made as to whether individual users exist.

At block 906, based on a determination at block 904 that individual users exist, individual users may be notified about an incident if they are configured to receive the information.

FIG. 10 illustrates a proactive Bot display of result data to illustrate operation of the apparatus 100 in accordance with an example of the present disclosure.

Referring to FIG. 10, some of the data analyzed by the apparatus 100 may be displayed by the proactive Bot, for example, for a user. The proactive Bot may also collect feedback data from a user, and use the feedback data to determine the relevance percentage of recommendations in order to better train and/or retrain the machine learning based models as disclosed herein. Incident resolution recommendations may be displayed, for example, for support personnel in a format as shown in a “Similar Historical Incidents” section 1000 of FIG. 10. Incident knowledge base article recommendations may be displayed, for example, for support personnel in a format as shown in a “Recommended KB Articles” section 1002 of FIG. 10. Other aspects such as incident identification, incident description, incident sub-category, whether the incident is to be escalated to Level-3 support, service level breach hours, etc., may be displayed at 1104.

Service Level Agreement Dashboard

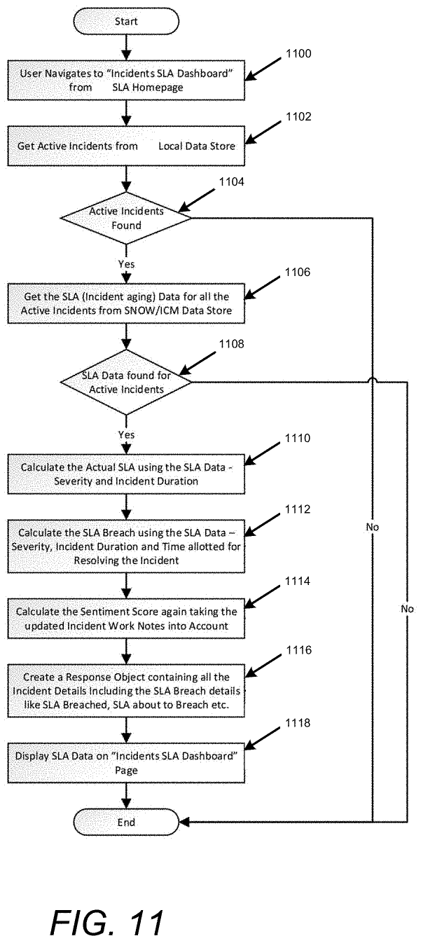

FIG. 11 illustrates a service level agreement flow to illustrate operation of the apparatus 100 in accordance with an example of the present disclosure.

Referring to FIG. 11, a service level agreement dashboard may provide incident related data including service level agreement details. For example, at block 1100, a user may navigate to a service level agreement dashboard page from a service level agreement homepage.

At block 1102, active incidents may be read from the data store (not shown), along with service level agreement data that may be applicable to the incidents.

At block 1104, a determination may be made as to whether active incidents are found.

At block 1106, based on a determination at block 1104 that active incidents are found, service level agreement (incident aging) data may be obtained for all of the active incidents.

At block 1108, a determination may be made as to whether service level agreement data is found for the active incidents.

At block 1110, the actual service level agreement value (e.g., hours) may be determined using the service level agreement data severity, and incident duration.

At block 1112, a calculation of service level agreement breach time may be performed based on incident severity, duration, and time allotted for resolving the incident. For example, if a severity is three (e.g., urgent), then the service level agreement time may be fixed at 24 hours. If the severity is four (e.g., standard), then the service level agreement time may be fixed at 72 hours. Further, the total active hours of the incident may be subtracted from the service level agreement time to obtain the exact service level breach time. This calculation may categorize incidents that are within service level agreement limits, and incidents that have breached the service level agreement time.

At block 1114, an updated user sentiment score may be determined.

At block 1116, data from block 1100 to 1114 may be categorized as either incidents near service level agreement breach, and incidents that have breached service level agreement.

At block 1118, the results from block 1116 may be displayed, for example, on an incident service level agreement dashboard page. For example, if there is an incident whose service level agreement time is 72 hours, and out of that 60 hours have already elapsed, then this incident may fall in an “incidents near service level agreement breach” category, and if there is another incident whose service level agreement time is 72 hours and out of that 74 hours have already elapsed, then this incident may fall in an “incidents breached service level agreement time” category.

Automated Problem Management

As part of automated (e.g., without human intervention) problem management, the machine learning based automated incident resolution model 108 may be used to categorize incidents into technical or functional categories.

Referring again to FIG. 8, the continuous learning machine learning based automated incident resolution model 108 may be trained in a similar manner as the machine learning based incident nature model 130 on the set of past and current incidents to predict if an incident is of a technical or a functional nature. Technical incidents may include incidents whose resolution steps (e.g., extensive configuration based solution mapping based on the error number and error description) are known, and such incidents may be solved without any human intervention. On the contrary, functional incidents may include incidents whose resolution steps are not known. A technical nature incident may be further analyzed if it is the appropriate candidate for automated resolution so that a predefined process may be utilized to resolve the incident without any human intervention, for example, from support personnel. If the incident cannot be resolved by automated resolution, or if the incident is of a functional category, then the related incident information may be collected and fed to the incident ticket router 112. For example, as illustrated in FIG. 3, after finding the recommendations, all of the results may be sent to the proactive Bot.

With respect to the feature of automated incident resolution, a report may be generated to identify areas of an application responsible for a maximum number of incidents. This report may be utilized, for example, by support personnel to understand issues with the application, and for re-factoring the application areas responsible for the bulk of the incidents. This determination may be performed by the machine learning based incident ticket creation and routing model 116 that is trained on an extensive set of incident categorization data (in a similar manner as disclosed herein with respect to FIG. 8).

Automated Resolution

Before an incident occurs, as well as after an incident is identified, the automated incident resolver 106 may read the associated data with respect to the issue 104 to determine whether the underlying issue is a candidate for automated resolution. In this regard, automated resolution represents a configurable process that lets the automated incident resolver 106 know if a process or a component may be implemented with a correct set of parameters to resolve the underlying issue. These set of parameters may represent the inputs (e.g., server name, job name, error number, error description, etc.) needed by a function to perform automated resolution. If the underlying issue can be resolved by the automated incident resolver 106, the automated incident resolver 106 may further determine whether the incident is resolved, and close any related incident ticket. If the underlying issue is not an appropriate candidate for automated resolution, further processing may proceed to determine recommendations by the incident recommender 122, user sentiment score, and Level-3 ticket prediction.

Real Time Integration with Incident Manager

The apparatus 100 may be integrated with an incident manager (not shown), which may include an incident management system such as (Service Now) SNOW and/or (Incident Management) ICM, which are examples of incident management systems where incidents are logged and maintained. These systems may return the incident related information when a call is made to their application programming interface for obtaining the data. The apparatus 100 may utilize application programming interfaces provided by the incident manager to obtain latest incident data. These application programming interfaces may return the real-time data, and may be referred to by using security details provided by such systems. For example, the real-time data may be obtained by consuming the SNOW/ICM application programming interfaces, and obtaining the data from their data stores (not shown). The incident data may be referred to by using read, create, and update service now application programming interfaces that are shared by the incident manager. The apparatus 100 may also connect to an incident manager database to consume bulk data. In this regard, cluster and frequently occurring incident data may be consumed using the data store. This data may be used to display incident information in the service level agreement dashboard, and may also be used to train/retrain the machine learning based predictive models as disclosed herein.

Automated Retraining

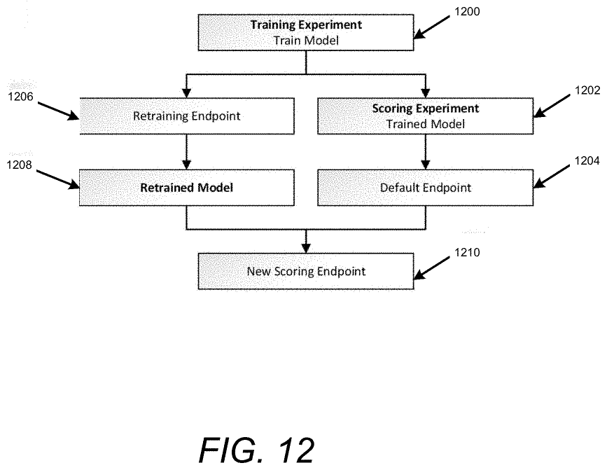

With respect to automated model retraining, the trained machine learning based predictive models (e.g., the machine learning based automated incident resolution model 108, the machine learning based incident classification model 114, the machine learning based incident ticket creation and routing model 116, and the machine learning based incident nature model 130) may be retrained with the latest information on a regular schedule. In this regard, FIG. 12 illustrates a machine learning based predictive model retraining flow to illustrate operation of the apparatus 100 in accordance with an example of the present disclosure.

Referring to FIG. 12, at block 1200, a training experiment may be created to train a machine learning based predictive model.

At block 1202, the trained machine learning based predictive model may be deployed, for example, as a web service. In this regard, the trained machine learning based predictive model may be implemented in a Cloud space, and the trained machine learning based predictive model may be utilized in real time prediction, for example, through REST application programming interfaces.

At block 1204, when a machine learning based predictive model is deployed as a web service, this may result in the generation of a “default endpoint”, which may represent a uniform resource locator address. An example of an endpoint may include “https://<<endpoint>>.services.azureml.net/workspaces/<<workspaceid>>/services/<<servicesid>>/execute?api-version=2.0&details=true”. The web service uniform resource locator, as well as the web service application programming interface may be obtained, and using these endpoints, the machine learning based predictive model may be utilized.

At block 1206, in order to enable retraining of the machine learning based predictive model, a web service output may be added to the trained machine learning based predictive model created at block 1200, and the machine learning based predictive model may be deployed as a web service. The web service endpoints that are thus generated may be treated as a common endpoint for all subsequent retraining calls.

At block 1208, in order to retrain the machine learning based predictive model with new data, the web service endpoint created at block 1206 may be utilized by providing its application programming interface key for authentication. This operation may represent a batch operation with input of the new data for model retraining. When the retraining operation is complete, the uniform resource locator of the retrained machine learning based predictive model may be returned.

At block 1210, the application programming interface may be called to replace the machine learning based predictive model for the “new scoring endpoint” (initially saved as part of the training experiment), with the one retrained above passing in its uniform resource locator generated at block 1208. The “new scoring endpoint” may include a new uniform resource locator similar to the sample endpoint as follows “https://<<endpoint>>.services.azureml.net/workspaces/<<workspaceid>>/services/<<serviceid>>/execute?api-version=2.0&details=true”. The “new scoring endpoint” may now use the retrained machine learning based predictive model. Using the “new scoring endpoint”, the machine learning based predictive model may be retrained on a regular schedule with the latest data.

Noise Reduction

The incident ticket router 112 may provide for the reduction of time consumed and maintenance of incident tickets that require no user intervention for their resolution. The incident ticket router 112 may determine whether a new incident ticket will be actionable or non-actionable type of ticket, for example by using the machine learning based incident classification model 114. The machine learning based incident classification model 114 may be trained by utilizing labeled historical incident tickets, where such historical incident tickets may be labeled as actionable or non-actionable. In real time, the machine learning based incident classification model 114 may be utilized to determine the type of incident ticket, and take action such as closure of the incident ticket in the event of a non-actionable incident ticket, and to further predict the nature of the associated incident ticket such as category, subcategory, configuration item, severity, assignment group in the event of an actionable incident ticket. An actionable incident ticket may include an issue that requires some human (e.g., manual) intervention to fix an issue. A non-actionable incident ticket may include an issue/incident that requires no human intervention. Therefore, if a given incident ticket is of a non-actionable nature, then the incident ticket may not need to be logged in. However, an actionable incident ticket may need to be logged. While logging or creating an incident ticket, some mandatory information specific to the incident ticket may need to be completed. Since the incident ticket logging (or creation) process may be automated as disclosed herein, the mandatory information of the incident ticket may be predicted, and may include a “category” of the incident ticket, a “subcategory” of the incident ticket, an “impacted application” which may also be referred to as a configuration item, a “severity” of the incident ticket, etc.

With respect to reduction of noise in incident tickets, the machine learning based incident classification model 114 may be trained based on actionable and non-actionable incident tickets to learn the patterns that differentiate a non-actionable incident ticket from an actionable incident ticket. The incident ticket router 112 may thus close non-actionable incident tickets with a “non-actionable” tag, without requiring any user intervention.

The incident ticket router 112 may read active incident ticket information such as description, short description, and other technical information, and pass this information on to the trained machine learning based incident classification model 114, which may utilize this information as input parameters.

The machine learning based incident classification model 114 may be trained as a two class machine learning model with input parameters as short description, description of the incident ticket, and other technical parameters such as the severity, email alias, etc. The machine learning based incident classification model 114 may include target classes that include “actionable” and “non-actionable”. The trained machine learning based incident classification model 114 may predict the likelihood of an incident ticket to be actionable and non-actionable.

An active incident ticket may be closed with a non-actionable tag of the incident ticket is identified to be non-actionable.

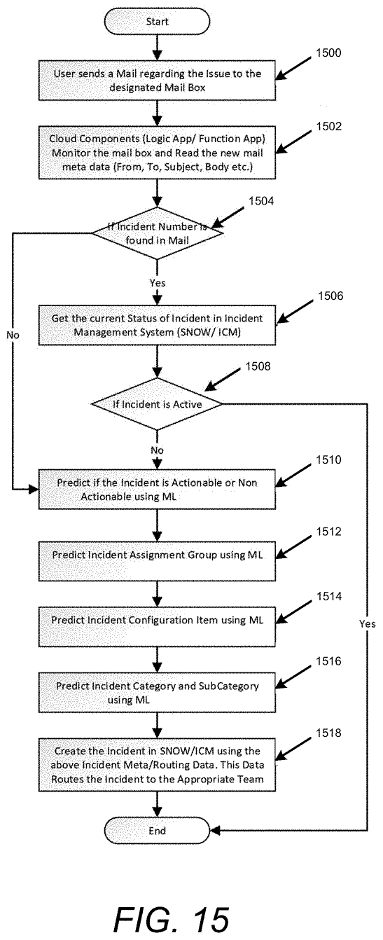

Further, other features of the incident ticket may be predicted and include, for example, subcategory, category, configuration item, and assignment group, if the incident ticket is identified as actionable (e.g., see FIG. 15).

Failure Prediction

FIG. 13 illustrates a failure prediction flow to illustrate operation of the apparatus 100 in accordance with an example of the present disclosure.

Referring to FIG. 13, the automated incident resolver 106 may determine proactively whether an issue (or alert) has a tendency to convert to an incident ticket. By doing so, preemptive actions may be taken to work towards resolving an issue before the issue leads to an incident. This may also provide for a reduction of incident tickets. Operation of the automated incident resolver 106 may be part of the proactive mode of incident management as disclosed herein.

The automated incident resolver 106 may be configured with respect to different systems that capture errors, logs, warnings, etc. The automated incident resolver 106 may collect issue (or alert) information from other systems that track application insights, log analytics, storage logs, application logs, database logs, application warnings, etc. This issue (or alert) information may be further processed to determine incident severity.

When an alert related to a new issue is received (e.g., at block 1300), at block 1302, the automated incident resolver 106 may determine whether the issue is actionable or non-actionable in nature by using the machine learning based automated incident resolution model 108, in a similar manner as the machine learning based incident classification model 114. If the incident is non-actionable (e.g., requires no actions from support personnel for its resolution), the no further actions may be taken for this issue.

If the issue is actionable, at block 1304, cosine similarity may be used to measure text similarity of the new issue with one or more clusters of historical issues. A cluster of incidents may include a collection of issues that are similar to other issues within the cluster, and are dissimilar to issues present in other clusters. For example, assuming that there is a set of 5000 historical issues, which are actionable in nature, based on the application of K-means clustering, five clusters may be formed based on the amount of information captured by these clusters. Each cluster may be represented by its centroid, which points to the center of the cluster. The cluster centroid may be used to determine which cluster is the closest to the new actionable issue. Therefore, cosine similarity may be used as a heuristic to measure distance of the issue with that of all cluster centroids to find the nearest cluster. In this regard, the cosine similarity may provide for the identification of a set of one or more clusters of historical issues that have similar context as the context of the new issue. The historical issues may refer to issues that have been triggered in the past, and have been captured by the automated incident resolver 106.

At block 1306, the automated incident resolver 106 may identify a pattern that exists between the new issue (or alert) and the historical issues (or alerts). The pattern may include a set of one or more features of an issue such as same-source system, priority, same context, similar trigger pattern, etc. In this regard, the new issues may be compared with other issues that are member of the cluster identified at block 1304, based on the issue information present in the repository. For example, the automated incident resolver 106 may determine how many issues have similar priority, such as P1, P2, P3, etc., have similar source system or point of origin such as infrastructure or network issue, database issue, security issue, and application issue, and have similar triggering pattern that means comparing the issue creation day and time to determine any common trends, etc. In this regard, the top three most occurring common behaviors may be determined as the dominant patterns.

At block 1308, the automated incident resolver 106 may identify one or more clusters that have a highest occurrence of dominant patterns identified at block 1306. In this regard, clusters that have the highest number of issues sharing the similar pattern with the new issue may be identified. These clusters may be termed as nearest clusters to the new issue. Once the dominant patterns are identified as illustrated at block 1306, the cluster (formed at block 1304) that has a maximum number of issues exhibiting the pattern may be identified. The heuristics used to find the nearest cluster may include the cluster that has the greatest number of issues sharing a similar pattern with the new issue.

At block 1310, the automated incident resolver 106 may consider the historical issues that are part of the nearest clusters identified at block 1308, and among these historical issues, identify the issues that lead to incident creation. In this regard, since cluster members share close relationships with each other, all of the issues that are part of the nearest clusters may share some common pattern with the new issue.

At block 1312, the automated incident resolver 106 may identify which issues in the nearest clusters lead to incident ticket creation, and which do not. The issue may thus be labeled as “incident worthy” or “incident not worthy”. Thus a label data set may be created to use for machine learning based model training.

At block 1314, the automated incident resolver 106 may train a two class machine learning based automated incident resolution model 108 using the issue information as input to the model, and flags (identified at block 1312) as target labels. In this regard, the issue information may be considered as this information provides meaningful insight about its incident as input to the machine learning model.

At block 1316, the automated incident resolver 106 may predict the likelihood of the new issue as “incident worthy” by applying the new issue on the trained machine learning based automated incident resolution model 108 created at block 1314.

At block 1318, if the new issue is predicted to be “incident worthy”, then the issue should be acted upon on before the issue leads to an incident.

Level-3 Incident Ticket Prediction

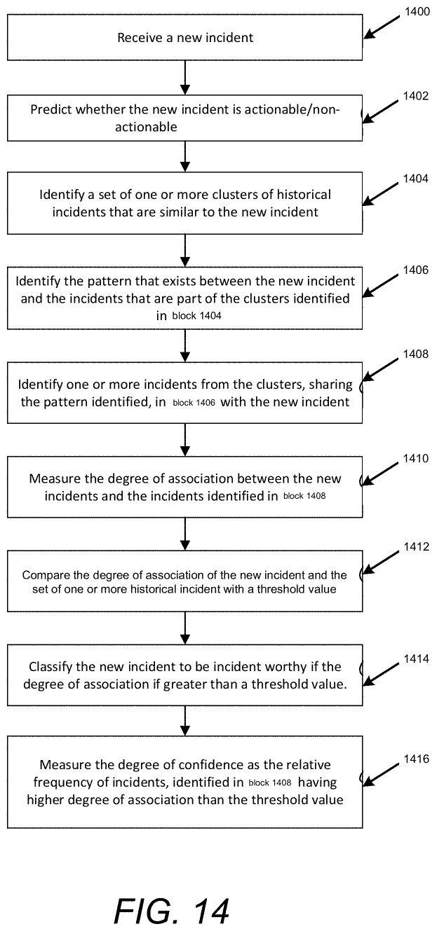

With respect to a determination of whether an incident ticket is a high-level (e.g., Level-3 on a scale of 1 to 3, where Level-1 represents low priority, Level-2 represents medium priority, and Level-3 represent high-priority) incident ticket, FIG. 14 illustrates a Level-3 ticket prediction flow to illustrate operation of the apparatus 100 in accordance with an example of the present disclosure.

Referring to FIG. 14, the incident ticket router 112 may determine whether high-level (e.g., Level-3) support personnel 120 may resolve the incident ticket or not. In this regard, by determining in advance whether the incident ticket is to be sent to high-level support personnel 120 as opposed to mid-level (e.g., Level-2) or low level (e.g., Level-1) support personnel, expenditure of resources and time may be minimized.

At block 1400, a new incident ticket 118 that represents a new incident 110 may be received.

At block 1402, the incident ticket router 112 may determine whether the new incident ticket is actionable or non-actionable as disclosed herein with respect to FIG. 15 (see block 1510). If the incident ticket is non-actionable where no actions are required from support personnel for resolution of the incident ticket, then the incident ticket may be closed.

At block 1404, if the incident ticket is actionable, the incident ticket router 112 may implement cosine similarity to measure the similarity of the new incident ticket with a set of one or more clusters of historical incidents. A cluster of incidents may include a collection of incidents which are similar to other incidents within the cluster and are dissimilar to incidents present in other clusters. For example, assuming that there is a set of 5000 historical incidents, which are actionable in nature, based on the application of K-means clustering, five (or a different number) clusters may be formed based on the amount of information captured by these clusters. Each cluster may be represented by its centroid, which points to the center of the cluster. The cluster centroid may be used to determine which cluster is the closest to the new actionable incident. Therefore, cosine similarity may be used as a heuristic to measure distance of the incident with that of all cluster centroids to find the nearest cluster. In this regard, the similarity analysis may provide for identification of a set of one or more clusters of historical incidents that are similar to the new incident identified in the incident ticket. The historical incidents may refer to past incidents resolved by the Level-3 support personnel.

At block 1406, the incident ticket router 112 may identify a similar behavior or pattern that exists between the new incident identified in the new incident ticket and historical incidents (that are member of the clusters identified at block 1404). The pattern may include a set of one or more features of an incident, such as name, severity, application, issue type, etc. In order to find similar behavior existing between the incident and the identified cluster members, a determination may be made as to how many incidents have similar severity (e.g., impact of the incident such as Sev1, Sev2, Sev3, etc.), how many incidents are impacting similar applications such as App1, App2, App3, etc., how many incidents have similar issue type such as network issues, database issues, etc. Further, all incident attributes in the repository may be compared to find common patterns. The top three most occurring common behaviors may be considered as the dominant patterns.

At block 1408, based on the dominant pattern identified at block 1406, the incident ticket router 112 may determine which historical incidents share the same pattern with the new incident identified in the incident ticket. In this regard, the incident ticket router 112 may identify a set of one or more similar historical incidents with respect to the new incident.

At block 1410, the incident ticket router 112 may measure the significance of association between the new incident and the set of one or more similar historical incidents identified at block 1408. According to an example, the incident ticket router 112 may utilize a Chi-square test, or other similar tests, to measure the degree of association.

At block 1412, the incident ticket router 112 may compare the significance of association of the new incident and the set of one or more historical incidents using a threshold value. An example of a threshold value for declaring statistical significance may include a p-value of less than 0.05. The threshold value may be a statistically significant value that suggests the likelihood of a relationship between two or more variables is caused by something other than chance. In this regard, the incident ticket router 112 may determine whether the significance of association of the new incident and a similar historical incident is less than the threshold value, and if so, the association may be determined to be very strong (this may hold true 95 out of 100 times).

At block 1416, the incident ticket router 112 may measure a confidence score by finding the relative frequency of the similar historical incidents which have a higher degree of association than the threshold value. In this regard, a high relative frequency may correspond to a greater number of historical incidents having strong association with the new incident, resulting in higher likelihood of the new incident becoming a Level-3 incident ticket.

Automated Incident Creation/Routing

FIG. 15 illustrates an incident creation and routing flow to illustrate operation of the apparatus 100 in accordance with an example of the present disclosure.

Referring to FIG. 15, at block 1500, when a user sends a notification regarding an issue that the user is experiencing, for example, with an application, at block 1502, the issue analyzer 102 may analyze metadata associated with the notification, and determine if the issue is a new issue or an existing issue. If the issue is new, the issue analyzer 102 may determine different parameters to route the issue correctly to the relevant support personnel.

At block 1504, the incident ticket router 112 may determine whether an incident associated with the issue is found in the notification from block 1500.

At block 1506, based on a determination at block 1504 that the incident associated with the issue is found in the notification from block 1500, the incident ticket router 112 may ascertain a current status of the incident.

At block 1508, the incident ticket router 112 may determine whether the incident is active or inactive.

At block 1510, based on a determination at block 1508 that the incident is inactive, the incident ticket router 112 may utilize the machine learning based incident classification model 114 to determine whether the incident is actionable or non-actionable.

At block 1512, the incident ticket router 112 may utilize the machine learning based incident ticket creation and routing model 116 to determine a correct assignment group for each incident ticket. In this regard, the machine learning based incident ticket creation and routing model 116 may be trained by learning ticket routing patterns from historical ticket assignments, and predicting the correct assignment group as disclosed herein with reference to FIGS. 2 and 8. The input parameters may include, for example, “short description”, “description”, and other information such as “email alias”, “configuration item”, etc. The “short description” may include high level information about an issue. The “description” may include detailed technical level information about an issue. The “configuration item” may include information about the application that is impacted by the issue. In order to determine the relevant support team (e.g., the support personnel 120) that may resolve an issue, as multiple support teams may work on various issues, finding a suitable support team to work on a new issue may be referred to as routing the issue to its appropriate support team. Further, assignment group may represent a unique identifier tagged to each support team, and a prediction may be made as to the appropriate support team (e.g., assignment group with the help of machine learning as disclosed herein). The output of the machine learning based incident ticket creation and routing model 116 may include a unique list of assignment groups that a ticket may be a part of. The routing and other such information may be used to create an incident with the incident management system (e.g., SNOW or ICM).

At block 1514, the incident ticket router 112 may utilize the machine learning based incident ticket creation and routing model 116 to predict an incident configuration item.

At block 1516, the incident ticket router 112 may utilize the machine learning based incident ticket creation and routing model 116 to predict an incident category and subcategory.

At block 1518, the incident ticket router 112 may utilize the routing and other such information to route the incident to the appropriate support personnel, and to create an incident with the incident management system (e.g., SNOW or ICM).

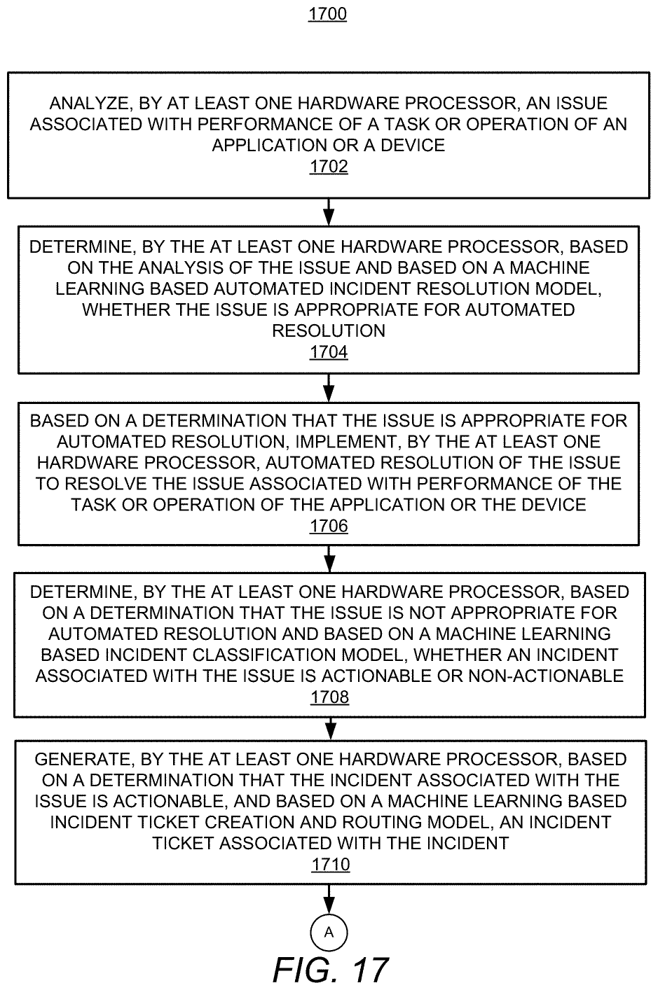

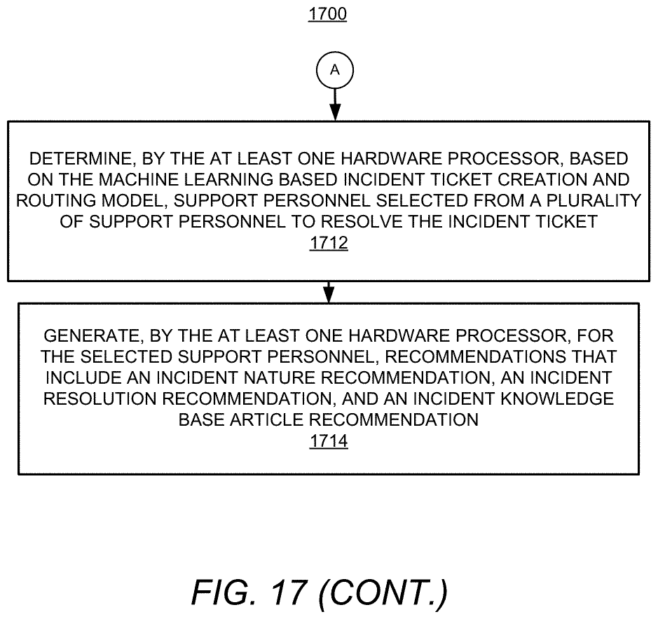

FIGS. 16-18 respectively illustrate an example block diagram 1600, a flowchart of an example method 1700, and a further example block diagram 1800 for machine learning based incident classification and resolution, according to examples. The block diagram 1600, the method 1700, and the block diagram 1800 may be implemented on the apparatus 100 described above with reference to FIG. 1 by way of example and not of limitation. The block diagram 1600, the method 1700, and the block diagram 1800 may be practiced in other apparatus. In addition to showing the block diagram 1600, FIG. 16 shows hardware of the apparatus 100 that may execute the instructions of the block diagram 1600. The hardware may include a processor 1602, and a memory 1604 storing machine readable instructions that when executed by the processor cause the processor to perform the instructions of the block diagram 1600. The memory 1604 may represent a non-transitory computer readable medium. FIG. 17 may represent an example method for machine learning based incident classification and resolution, and the steps of the method. FIG. 18 may represent a non-transitory computer readable medium 1802 having stored thereon machine readable instructions to provide machine learning based incident classification and resolution according to an example. The machine readable instructions, when executed, cause a processor 1804 to perform the instructions of the block diagram 1800 also shown in FIG. 18.

The processor 1602 of FIG. 16 and/or the processor 1804 of FIG. 18 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1802 of FIG. 18), such as hardware storage devices (e.g., RAM (random access memory), ROM (read only memory), EPROM (erasable, programmable ROM), EEPROM (electrically erasable, programmable ROM), hard drives, and flash memory). The memory 1604 may include a RAM, where the machine readable instructions and data for a processor may reside during runtime.

Referring to FIGS. 1-16, and particularly to the block diagram 1600 shown in FIG. 16, the memory 1604 may include instructions 1606 to analyze an issue 104 associated with performance of a task or operation of an application or a device.

The processor 1602 may fetch, decode, and execute the instructions 1608 to determine, based on the analysis of the issue 104 and based on a machine learning based automated incident resolution model 108, whether the issue 104 is appropriate for automated resolution.

Based on a determination that the issue 104 is appropriate for automated resolution, the processor 1602 may fetch, decode, and execute the instructions 1610 to implement automated resolution of the issue 104 to resolve the issue 104 associated with performance of the task or operation of the application or the device.

The processor 1602 may fetch, decode, and execute the instructions 1612 to determine, based on a determination that the issue 104 is not appropriate for automated resolution and based on a machine learning based incident classification model 114, whether the incident 110 associated with the issue 104 is actionable or non-actionable.

The processor 1602 may fetch, decode, and execute the instructions 1614 to generate, based on a determination that the incident 110 associated with the issue 104 is actionable, and based on a machine learning based incident ticket creation and routing model 116, an incident ticket 118 associated with the incident 110.

The processor 1602 may fetch, decode, and execute the instructions 1616 to determine, based on the machine learning based incident ticket creation and routing model 116, support personnel 120 selected from a plurality of support personnel to resolve the incident ticket 118.

Referring to FIGS. 1-14 and 17, and particularly FIG. 17, for the method 1700, at block 1702, the method may include analyzing an issue 104 associated with performance of a task or operation of an application or a device.

At block 1704, the method may include determining, based on the analysis of the issue 104 and based on a machine learning based automated incident resolution model 108, whether the issue 104 is appropriate for automated resolution.

Based on a determination that the issue 104 is appropriate for automated resolution, at block 1706, the method may include implementing automated resolution of the issue 104 to resolve the issue 104 associated with performance of the task or operation of the application or the device.

At block 1708, the method may include determining, based on a determination that the issue 104 is not appropriate for automated resolution and based on a machine learning based incident classification model 114, whether the incident 110 associated with the issue 104 is actionable or non-actionable.

At block 1710, the method may include generating, based on a determination that the incident 110 associated with the issue 104 is actionable, and based on a machine learning based incident ticket creation and routing model 116, an incident ticket 118 associated with the incident 110.

At block 1712, the method may include may determining, based on the machine learning based incident ticket creation and routing model 116, support personnel 120 selected from a plurality of support personnel to resolve the incident ticket 118.

At block 1714, the method may include generating, for the selected support personnel 120, recommendations that include an incident nature recommendation 124, an incident resolution recommendation 126, and an incident knowledge base article recommendation 128.

Referring to FIGS. 1-14 and 18, and particularly FIG. 18, for the block diagram 1800, the non-transitory computer readable medium 1802 may include instructions 1806 to analyze an issue 104 associated with performance of a task or operation of an application or a device.

The processor 1804 may fetch, decode, and execute the instructions 1808 to determine, based on the analysis of the issue 104 and based on a machine learning based automated incident resolution model 108, whether the issue 104 is appropriate for automated resolution.

Based on a determination that the issue 104 is appropriate for automated resolution, the processor 1804 may fetch, decode, and execute the instructions 1810 to implement automated resolution of the issue 104 to resolve the issue 104 associated with performance of the task or operation of the application or the device.

The processor 1804 may fetch, decode, and execute the instructions 1812 to determine, based on a determination that the issue 104 is not appropriate for automated resolution and based on a machine learning based incident classification model 114, whether the incident 110 associated with the issue 104 is actionable or non-actionable.

The processor 1804 may fetch, decode, and execute the instructions 1814 to generate, based on a determination that the incident 110 associated with the issue 104 is actionable, and based on a machine learning based incident ticket creation and routing model 116, an incident ticket 118 associated with the incident 110.

The processor 1804 may fetch, decode, and execute the instructions 1816 to determine, based on the machine learning based incident ticket creation and routing model 116, support personnel 120 selected from a plurality of support personnel to resolve the incident ticket 118.

The processor 1804 may fetch, decode, and execute the instructions 1818 to determine, for the incident 110, a service level agreement severity and an incident duration.

The processor 1804 may fetch, decode, and execute the instructions 1820 to determine, based on the service level agreement severity, the incident duration, and time allotted for resolving the incident 110, a service level agreement breach.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A machine learning based incident classification and resolution apparatus comprising:
an issue analyzer, executed by at least one hardware processor, to
analyze an issue associated with performance of a task or operation of an application or a device;
an automated incident resolver, executed by the at least one hardware processor, to
determine, based on the analysis of the issue and based on a machine learning based automated incident resolution model, whether the issue is appropriate for automated resolution; and
based on a determination that the issue is appropriate for automated resolution, implement automated resolution of the issue to resolve the issue associated with performance of the task or operation of the application or the device; and
an incident ticket router, executed by the at least one hardware processor, to
determine, based on a determination that the issue is not appropriate for automated resolution and based on a machine learning based incident classification model, whether an incident associated with the issue is actionable or non-actionable;
generate, based on a determination that the incident associated with the issue is actionable, and based on a machine learning based incident ticket creation and routing model, an incident ticket associated with the incident; and
determine, based on the machine learning based incident ticket creation and routing model, support personnel selected from a plurality of support personnel to resolve the incident ticket.

2. The apparatus according to claim 1, further comprising:
an incident recommender, executed by the at least one hardware processor, to
generate, for the selected support personnel, recommendations that include an incident nature recommendation, an incident resolution recommendation, and an incident knowledge base article recommendation.

3. The apparatus according to claim 2, wherein the incident recommender is executed by the at least one hardware processor, to generate, for the selected support personnel, the incident nature recommendation by:
ascertaining incident data for the incident;
analyzing the incident data by a trained machine learning based incident nature model; and
determining, based on the analysis of the incident data by the trained machine learning based incident nature model, the incident nature recommendation.

4. The apparatus according to claim 2, wherein the incident recommender is executed by the at least one hardware processor, to generate, for the selected support personnel, the incident resolution recommendation by:
generating incident metadata for the incident;
determining, based on the incident metadata, key phrases associated with the incident;
determining, based on the key phrases associated with the incident, a historical incident, from a plurality of historical incidents, that includes a high confidence score based on a match to the incident; and
determining, based on the historical incident, the incident resolution recommendation.

5. The apparatus according to claim 2, wherein the incident recommender is executed by the at least one hardware processor, to generate, for the selected support personnel, the incident knowledge base article recommendation by:
generating incident metadata for the incident;
determining, based on the incident metadata, key phrases associated with the incident;
determining, based on the key phrases associated with the incident, a knowledge base article, from a plurality of knowledge base articles, that includes a high confidence score based on a match to the incident; and
determining, based on the knowledge base article, the incident knowledge base article recommendation.

6. The apparatus according to claim 1, wherein the incident ticket router is executed by the at least one hardware processor to determine, based on the machine learning based incident ticket creation and routing model, support personnel selected from a plurality of support personnel to resolve the incident ticket by:
training, based on historical incident tickets that qualify for high level support, the machine learning based incident ticket creation and routing model;
determining, based on the trained machine learning based incident ticket creation and routing model, whether the incident ticket qualifies for the high level support; and
based on a determination that the incident ticket qualifies for the high level support, determining the support personnel associated with the high level support to resolve the incident ticket.

7. The apparatus according to claim 6, wherein the incident ticket router is executed by the at least one hardware processor to determine, based on the trained machine learning based incident ticket creation and routing model, whether the incident ticket qualifies for the high level support by:
identifying, based on the trained machine learning based incident ticket creation and routing model, clusters of historical incidents that are similar to the incident;
identifying incidents, from the identified clusters of historical incidents, that share a pattern with the incident; and
determining, based on an analysis of the pattern and a degree of association between the identified incidents and the incident, whether the incident ticket qualifies for the high level support.

8. The apparatus according to claim 1, wherein the automated incident resolver is executed by the at least one hardware processor to determine, based on the analysis of the issue and based on the machine learning based automated incident resolution model, whether the issue is appropriate for automated resolution by:
determining, based on the analysis of the issue that includes at least one of memory spikes, disk utilization spikes, or anomalous application usage patterns, and based on the machine learning based automated incident resolution model, whether the issue includes a potential to turn into an incident; and
based on a determination that the issue includes the potential to turn into the incident, determining, based on the machine learning based automated incident resolution model, whether the issue is appropriate for automated resolution.

9. The apparatus according to claim 1, further comprising:
a service level agreement analyzer, executed by the at least one hardware processor, to
determine, for the incident, a service level agreement severity and an incident duration; and
determine, based on the service level agreement severity, the incident duration, and time allotted for resolving the incident, a service level agreement breach.

10. The apparatus according to claim 1, wherein the incident ticket router is executed by the at least one hardware processor to determine, based on the determination that the issue is not appropriate for automated resolution and based on the machine learning based incident classification model, whether the incident associated with the issue is actionable or non-actionable by:
comparing, based on the machine learning based incident classification model, the incident to historical incidents to determine whether the incident associated with the issue is actionable or non-actionable.

11. A method for machine learning based incident classification and resolution, the method comprising:
analyzing, by at least one hardware processor, an issue associated with performance of a task or operation of an application or a device;
determining, by the at least one hardware processor, based on the analysis of the issue and based on a machine learning based automated incident resolution model, whether the issue is appropriate for automated resolution;
based on a determination that the issue is appropriate for automated resolution, implementing, by the at least one hardware processor, automated resolution of the issue to resolve the issue associated with performance of the task or operation of the application or the device;
determining, by the at least one hardware processor, based on a determination that the issue is not appropriate for automated resolution and based on a machine learning based incident classification model, whether an incident associated with the issue is actionable or non-actionable;
generating, by the at least one hardware processor, based on a determination that the incident associated with the issue is actionable, and based on a machine learning based incident ticket creation and routing model, an incident ticket associated with the incident;
determining, by the at least one hardware processor, based on the machine learning based incident ticket creation and routing model, support personnel selected from a plurality of support personnel to resolve the incident ticket; and
generating, by the at least one hardware processor, for the selected support personnel, recommendations that include an incident nature recommendation, an incident resolution recommendation, and an incident knowledge base article recommendation.

12. The method according to claim 11, wherein generating, for the selected support personnel, the incident nature recommendation further comprises:
ascertaining incident data for the incident;
analyzing the incident data by a trained machine learning based incident nature model; and
determining, based on the analysis of the incident data by the trained machine learning based incident nature model, the incident nature recommendation.

13. The method according to claim 11, wherein generating, for the selected support personnel, the incident resolution recommendation further comprises:
generating incident metadata for the incident;
determining, based on the incident metadata, key phrases associated with the incident;
determining, based on the key phrases associated with the incident, a historical incident, from a plurality of historical incidents, that includes a high confidence score based on a match to the incident; and
determining, based on the historical incident, the incident resolution recommendation.

14. The method according to claim 11, wherein generating, for the selected support personnel, the incident knowledge base article recommendation further comprises:
generating incident metadata for the incident;
determining, based on the incident metadata, key phrases associated with the incident;
determining, based on the key phrases associated with the incident, a knowledge base article, from a plurality of knowledge base articles, that includes a high confidence score based on a match to the incident; and
determining, based on the knowledge base article, the incident knowledge base article recommendation.

15. A non-transitory computer readable medium having stored thereon machine readable instructions, the machine readable instructions, when executed by at least one hardware processor, cause the at least one hardware processor to:
analyze an issue associated with performance of a task or operation of an application or a device;
determine, based on the analysis of the issue and based on a machine learning based automated incident resolution model, whether the issue is appropriate for automated resolution;
based on a determination that the issue is appropriate for automated resolution, implement automated resolution of the issue to resolve the issue associated with performance of the task or operation of the application or the device;
determine, based on a determination that the issue is not appropriate for automated resolution and based on a machine learning based incident classification model, whether an incident associated with the issue is actionable or non-actionable;
generate, based on a determination that the incident associated with the issue is actionable, and based on a machine learning based incident ticket creation and routing model, an incident ticket associated with the incident;
determine, based on the machine learning based incident ticket creation and routing model, support personnel selected from a plurality of support personnel to resolve the incident ticket;
determine, for the incident, a service level agreement severity and an incident duration; and
determine, based on the service level agreement severity, the incident duration, and time allotted for resolving the incident, a service level agreement breach.

16. The non-transitory computer readable medium according to claim 15, wherein the machine readable instructions, when executed by the at least one hardware processor, further cause the at least one hardware processor to:
generate, for the selected support personnel, recommendations that include an incident nature recommendation, an incident resolution recommendation, and an incident knowledge base article recommendation.

17. The non-transitory computer readable medium according to claim 15, wherein the machine readable instructions to determine, based on the machine learning based incident ticket creation and routing model, support personnel selected from a plurality of support personnel to resolve the incident ticket, when executed by the at least one hardware processor, further cause the at least one hardware processor to:
train, based on historical incident tickets that qualify for high level support, the machine learning based incident ticket creation and routing model;
determine, based on the trained machine learning based incident ticket creation and routing model, whether the incident ticket qualifies for the high level support; and
based on a determination that the incident ticket qualifies for the high level support, determine the support personnel associated with the high level support to resolve the incident ticket.

18. The non-transitory computer readable medium according to claim 17, wherein the machine readable instructions to determine, based on the trained machine learning based incident ticket creation and routing model, whether the incident ticket qualifies for the high level support, when executed by the at least one hardware processor, further cause the at least one hardware processor to:
identify, based on the trained machine learning based incident ticket creation and routing model, clusters of historical incidents that are similar to the incident;
identify incidents, from the identified clusters of historical incidents, that share a pattern with the incident; and
determine, based on an analysis of the pattern and a degree of association between the identified incidents and the incident, whether the incident ticket qualifies for the high level support.

19. The non-transitory computer readable medium according to claim 15, wherein the machine readable instructions to determine, based on the analysis of the issue and based on the machine learning based automated incident resolution model, whether the issue is appropriate for automated resolution, when executed by the at least one hardware processor, further cause the at least one hardware processor to:
determine, based on the analysis of the issue that includes at least one of memory spikes, disk utilization spikes, or anomalous application usage patterns, and based on the machine learning based automated incident resolution model, whether the issue includes a potential to turn into an incident; and
based on a determination that the issue includes the potential to turn into the incident, determine, based on the machine learning based automated incident resolution model, whether the issue is appropriate for automated resolution.

20. The non-transitory computer readable medium according to claim 15, wherein the machine readable instructions to determine, based on the determination that the issue is not appropriate for automated resolution and based on the machine learning based incident classification model, whether the incident associated with the issue is actionable or non-actionable, when executed by the at least one hardware processor, further cause the at least one hardware processor to:
compare, based on the machine learning based incident classification model, the incident to historical incidents to determine whether the incident associated with the issue is actionable or non-actionable.
